(19) United States
(12) Patent Application Publication
(10) Pub. No.: US 2026/0001346 A1
(43) Pub. Date: Jan. 1, 2026

(54) Liquid Ejecting Head And Liquid Ejecting Apparatus

(71) Applicant: SEIKO EPSON CORPORATION, Tokyo (JP)

(72) Inventors: Hiroyuki HAGIWARA, Matsumoto (JP); Shun KATSUIE, Matsumoto (JP)

(21) Appl. No.: 19/250,551

(22) Filed: Jun. 26, 2025

(30) Foreign Application Priority Data
Jun. 27, 2024 (JP) 2024-104472

(51) Int. Cl. B41J 2/21; B41J 2/14; B41J 2/175

(52) U.S. Cl. CPC B41J 2/2103; B41J 2/14233; B41J 2/175

(57) ABSTRACT

A liquid ejecting head includes a first head chip, a second head chip, and a fixing plate, in which the fixing plate includes a first flat plate portion including a first fixing surface to which the first head chip is fixed, and a first surface that is opposite from the first fixing surface, and a second flat plate portion including a second fixing surface to which the second head chip is fixed, and a second surface that is opposite from the second fixing surface, the first surface and the second surface are caused to face different directions from each other by bending the fixing plate, and in a view from a first direction along an intersection line between the first surface and the second surface, an angle formed between the first surface and the second surface is less than 180 degrees.

The present application is based on, and claims priority from JP Application Serial Number 2024-104472, filed Jun. 27, 2024, the disclosure of which is hereby incorporated by reference herein in its entirety.

### BACKGROUND

### 1. Technical Field

The present disclosure relates to a liquid ejecting head and a liquid ejecting apparatus.

### 2. Related Art

An apparatus such as a printer of an ink jet system generally includes a liquid ejecting head that ejects liquid such as ink. The liquid ejecting head according to JP-A-2015-39804 includes a plurality of head chips that eject liquid such as ink, and a fixing plate on which the plurality of head chips are arranged.

In the related art, arranging the plurality of head chips on one fixing plate parallel to a plane has only been studied, and variations in arranging the plurality of head chips on the fixing plate have not been sufficiently studied.

### SUMMARY

According to an aspect of the present disclosure, there is provided a liquid ejecting head including a plurality of head chips that includes a first head chip including a plurality of first nozzles that eject liquid, and a second head chip including a plurality of second nozzles that eject the liquid, and a fixing plate that includes a first exposed opening portion exposing the plurality of first nozzles outward, and a second exposed opening portion exposing the plurality of second nozzles outward, and to which the plurality of head chips are fixed, in which the fixing plate includes a first flat plate portion including a first fixing surface to which the first head chip is fixed, and a first surface opposite to the first fixing surface, and a second flat plate portion including a second fixing surface to which the second head chip is fixed, and a second surface opposite to the second fixing surface, the first surface and the second surface are caused to face different directions from each other by bending the fixing plate, and in a view from a first direction along an intersection line between the first surface and the second surface, an angle formed between the first surface and the second surface is less than 180 degrees.

According to another aspect of the present disclosure, there is provided a liquid ejecting head including a plurality of head chips that includes a first head chip including a plurality of first nozzles that eject liquid, and a second head chip including a plurality of second nozzles that eject the liquid, and a fixing plate that includes a first exposed opening portion exposing the plurality of first nozzles outward, and a second exposed opening portion exposing the plurality of second nozzles outward, and to which the plurality of head chips are fixed, in which the fixing plate includes a first flat plate portion including a first fixing surface to which the first head chip is fixed, and a first surface opposite to the first fixing surface, and a second flat plate portion including a second fixing surface to which the second head chip is fixed, and a second surface opposite to the second fixing surface, the first surface and the second surface are caused to face different directions from each other by bending the fixing plate, and in a view from a first direction along an intersection line between the first surface and the second surface, a first half-line extending in a direction perpendicular to the first surface from the first surface and a second half-line extending in a direction perpendicular to the second surface from the second surface intersect with each other.

According to still another aspect of the present disclosure, there is provided a liquid ejecting apparatus including the liquid ejecting head of the above aspects, and a transport portion that transports a medium on which liquid ejected from the liquid ejecting head lands.

### BRIEF DESCRIPTION OF THE DRAWINGS

FIG. 1 is a schematic view of a liquid ejecting apparatus according to a first embodiment.

FIG. 2 is an exploded perspective view of a liquid ejecting head according to the first embodiment.

FIG. 3 is an exploded perspective view of a head chip.

FIG. 4 is a cross-sectional view of the head chip.

FIG. 5 is a schematic cross-sectional view of the liquid ejecting head according to the first embodiment.

FIG. 6 is a bottom view of the liquid ejecting head according to the first embodiment.

FIG. 7 is a descriptive view of the liquid ejecting head according to the first embodiment.

FIG. 8 is a descriptive view of a liquid ejecting head in the related art.

FIG. 9 is a bottom view of a liquid ejecting head according to Modification Example 1 of the first embodiment.

FIG. 10 is a bottom view of a liquid ejecting head according to Modification Example 2 of the first embodiment.

FIG. 11 is a bottom view of a liquid ejecting head according to Modification Example 3 of the first embodiment.

FIG. 12 is a schematic cross-sectional view of a liquid ejecting head according to Modification Example 4 of the first embodiment.

FIG. 13 is a schematic view of a liquid ejecting apparatus according to a second embodiment.

FIG. 14 is a bottom view of the liquid ejecting head according to the second embodiment.

FIG. 15 is a descriptive view of the liquid ejecting head according to the second embodiment.

FIG. 16 is a descriptive view of the liquid ejecting head in the related art.

FIG. 17 is a bottom view of a liquid ejecting head according to a modification example of the second embodiment.

FIG. 18 is a descriptive view of the liquid ejecting head according to the modification example of the second embodiment.

### DESCRIPTION OF EMBODIMENTS

Hereinafter, preferred embodiments according to the present disclosure will be described with reference to the accompanying drawings. In the drawings, dimensions and scales of each portion are not exactly the same as the actual dimensions and scales, and some parts are schematically illustrated for easy understanding. The scope of the present disclosure is not limited to the embodiments unless it is particularly stated that the present disclosure is limited in the following description.

### 1. First Embodiment

### 1-1. Schematic Configuration of Liquid Ejecting Apparatus

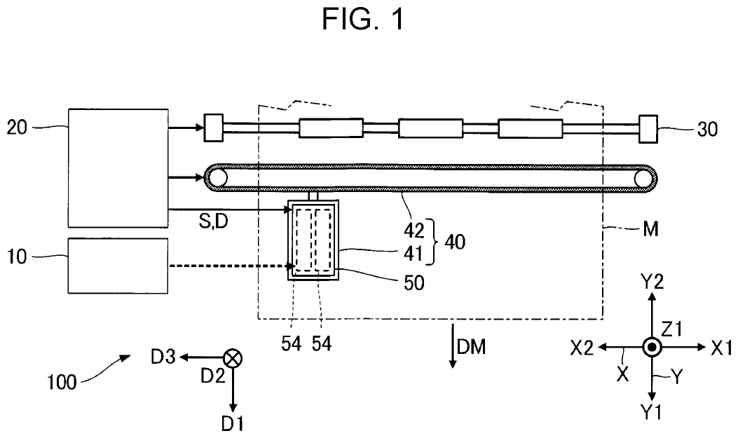

FIG. 1 is a schematic view of a liquid ejecting apparatus 100 according to a first embodiment. For convenience, an X axis, a Y axis, and a Z axis intersecting with each other will be appropriately used in the following description. Hereinafter, one direction along the X axis will be referred to as an X1 direction, and a direction opposite to the X1 direction will be referred to as an X2 direction. Similarly, directions opposite to each other along the Y axis will be referred to as a Y1 direction and a Y2 direction. Directions opposite to each other along the Z axis will be referred to as a Z1 direction and a Z2 direction. Typically, the Z axis is a vertical axis, and the Z2 direction corresponds to a downward direction in a vertical direction. The Z axis may not be the vertical axis.

The X axis, the Y axis, and the Z axis are typically orthogonal to each other but are not limited to this and may intersect with each other at an angle within a range of, for example, 80° or more and 100° or less.

The present embodiment illustrates an aspect of applying a liquid ejecting head 50 (described later) to a serial system. The Y1 direction corresponds to a first direction D1, the Z2 direction corresponds to a second direction D2, and the X2 direction corresponds to a third direction D3.

The liquid ejecting apparatus 100 is an ink jet system printing apparatus that ejects ink which is an example of “liquid” to a medium M as a droplet. The medium M is typically a printing sheet. The medium M is not limited to the printing sheet and may be, for example, a printing target of any material such as a resin film or a cloth.

As illustrated in FIG. 1, the liquid ejecting apparatus 100 includes a liquid storage portion 10, a control unit 20, a transport portion 30, a moving mechanism 40, and the liquid ejecting head 50.

The liquid storage portion 10 is a container storing the ink. Examples of a specific aspect of the liquid storage portion 10 include a cartridge attachable to and detachable from the liquid ejecting apparatus 100, a bag-shaped ink pack formed of a flexible film, and a container such as an ink tank replenishable with ink.

While illustration is not provided, the liquid storage portion 10 includes a plurality of containers storing different types of ink. The ink stored in the plurality of containers is not particularly limited. Examples of the ink include cyan ink, magenta ink, yellow ink, black ink, clear ink, white ink, and treatment liquid, and a combination of two or more thereof is used. A composition of the ink is not particularly limited. For example, the ink may be water-based ink obtained by dissolving a coloring material such as dye or pigment in a water-based solvent, a solvent-based ink obtained by dissolving a coloring material in an organic solvent, or ultraviolet-curable ink.

The control unit 20 controls an operation of each element of the liquid ejecting apparatus 100. For example, the control unit 20 includes a processing circuit such as a central processing unit (CPU) or a field programmable gate array (FPGA), and a storage circuit such as a semiconductor memory. The control unit 20 outputs a drive signal D and a control signal S to the liquid ejecting head 50. The drive signal D is a signal including a drive pulse for driving a drive element of the liquid ejecting head 50. The control signal S is a signal for designating whether or not to supply the drive signal D to the drive element.

The transport portion 30 transports the medium M in a transport direction DM under control of the control unit 20. In the example illustrated in FIG. 1, the transport direction DM is the Y1 direction. In the example illustrated in FIG. 1, the transport portion 30 includes a transport roller elongated along the X axis, and a motor (not illustrated) that rotates the transport roller. The transport portion 30 is not limited to the configuration using the transport roller and may be configured to use, for example, a drum or an endless belt that transports the medium M in a state where the medium M clings to its outer peripheral surface by electrostatic force or the like.

The moving mechanism 40 causes the liquid ejecting head 50 to reciprocate in the X1 direction and the X2 direction under control of the control unit 20. In the example illustrated in FIG. 1, the moving mechanism 40 includes a substantially box-shaped support body 41 called a carriage accommodating the liquid ejecting head 50, and a transport belt 42 to which the support body 41 is fixed. The support body 41 supports the liquid ejecting head 50 and is made of a metal material. In addition to the liquid ejecting head 50, the liquid storage portion 10 may be mounted on the support body 41. A plurality of liquid ejecting heads 50 may be mounted on the support body 41.

The liquid ejecting head 50 includes a plurality of head chips 54 and ejects the ink supplied from the liquid storage portion 10 to the medium M in the Z2 direction from each of a plurality of nozzles of each head chip 54 under control of the control unit 20. By performing this ejection in parallel with transport of the medium M via the transport portion 30 and reciprocating movement of the liquid ejecting head 50 via the moving mechanism 40, a predetermined image of the ink is formed on a surface of the medium M. The transport portion 30 transports the medium M on which the ink ejected from the liquid ejecting head 50 lands.

### 1-2. Liquid Ejecting Head

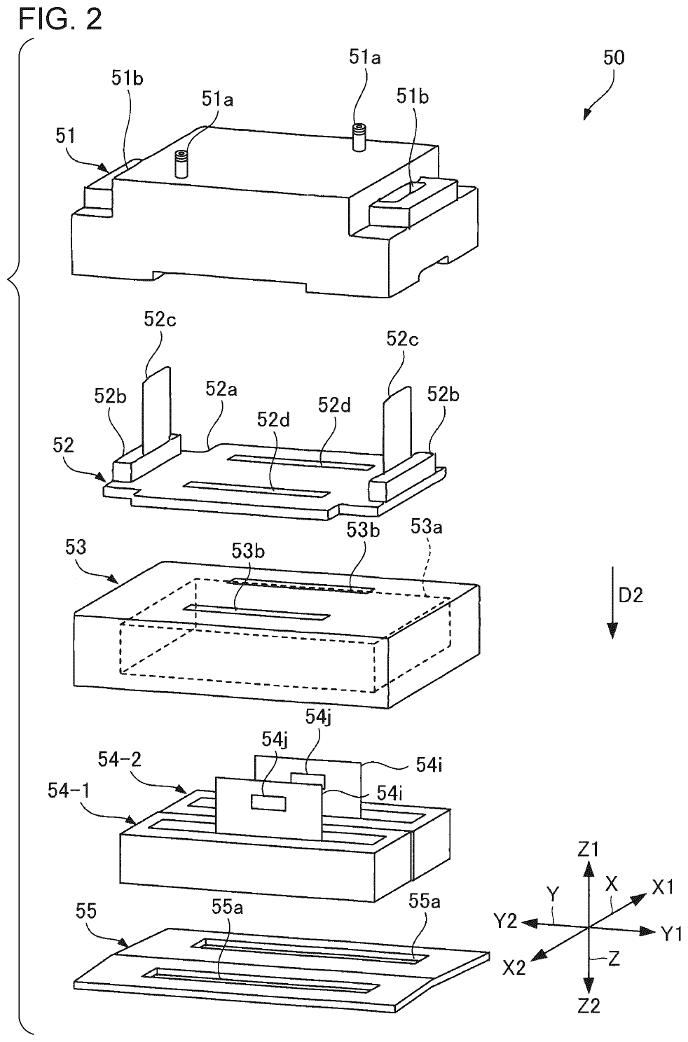

FIG. 2 is an exploded perspective view of the liquid ejecting head 50 according to the first embodiment. As illustrated in FIG. 2, the liquid ejecting head 50 includes a flow path structure 51, a substrate unit 52, a holder 53, two head chips 54-1 and 54-2, and a fixing plate 55.

Each of the head chips 54-1 and 54-2 is the head chip 54 illustrated in FIG. 1. The head chip 54-1 is an example of a “first head chip”, and the head chip 54-2 is an example of a “second head chip”. Hereinafter, each of the head chips 54-1 and 54-2 will be referred to as the head chip 54 unless the head chips are distinguished from each other.

The flow path structure 51, the substrate unit 52, the holder 53, the head chips 54-1 and 54-2, and the fixing plate 55 are disposed in this order in an overlapping manner in the Z2 direction. These are appropriately joined to each other through screwing, an adhesive, or the like. Hereinafter, each portion of the liquid ejecting head 50 will be described in order.

The flow path structure 51 is a structure provided with one or a plurality of flow paths for supplying the ink stored in the liquid storage portion 10 to the two head chips 54. In the present embodiment, as will be described later, different types of ink are supplied to the head chips 54-1 and 54-2. Thus, the flow path structure 51 is provided with the plurality of flow paths. When the same type of ink is supplied to the head chips 54-1 and 54-2, the flow path structure 51 may be provided with one flow path for supplying the ink to the head chips 54-1 and 54-2 in a distributed manner. While illustration is not provided, the flow path structure 51 is configured with a laminate obtained by laminating a plurality of substrates in a direction along the Z axis. Each of the plurality of substrates is appropriately provided with a groove and a hole for a supply flow path, a filter chamber including a filter for capturing a foreign matter contained in the ink, and the like (described later). The plurality of substrates are joined to each other through, for example, an adhesive, brazing, welding, or screwing. A sheet-shaped sealing member made of a rubber material or the like may be appropriately disposed between the plurality of substrates, as necessary. The number, thickness, or the like of the substrates constituting the flow path structure 51 is determined in accordance with an aspect such as a shape of the supply flow path and is not particularly limited and may be any number, thickness, or the like. Each of the plurality of substrates is not particularly limited and is made of, for example, metal, ceramic, or a resin composition.

While illustration is not provided, the flow path structure 51 is provided with two supply flow paths provided for each of two types of ink. Each of the two supply flow paths includes one inlet for receiving supply of the ink and one discharge port for discharging the ink. The inlet of each supply flow path is provided on a surface of the flow path structure 51 facing the Z1 direction. Meanwhile, the discharge port of each supply flow path is provided on a surface of the flow path structure 51 facing the Z2 direction.

The flow path structure 51 includes one or a plurality of flow paths communicating with each flow path of the plurality of head chips 54 and is configured by laminating a plurality of substrates. The second direction D2 is a direction in which the plurality of substrates are laminated, and is the Z2 direction in the present embodiment.

A plurality of coupling pipes 51a are provided on the surface of the flow path structure 51 facing the Z1 direction. Each of the plurality of coupling pipes 51a is a pipe body that protrudes from the surface of the flow path structure 51 facing the Z1 direction. In the example illustrated in FIG. 2, two coupling pipes 51a corresponding to the two supply flow paths are provided in the flow path structure 51, and each coupling pipe 51a is coupled to the inlet of the corresponding supply flow path. The two coupling pipes 51a are coupled to separate ink tubes to receive supply of different types of ink and are coupled to the liquid storage portion 10 through the ink tubes.

The flow path structure 51 is provided with a plurality of wiring holes 51b through which wiring 52c (described later) of the substrate unit 52 passes. The flow path structure 51 is provided with a hole (not illustrated) and is fixed to the holder 53 through screwing using the hole.

The substrate unit 52 is an assembly including a mounted component for electrically coupling the liquid ejecting head 50 to the control unit 20. The substrate unit 52 includes a circuit substrate 52a, a connector 52b, and the wiring 52c.

The circuit substrate 52a is a printed wiring substrate such as a rigid wiring substrate including wiring for electrically coupling each head chip 54 to the connector 52b. The circuit substrate 52a is disposed between the flow path structure 51 and the holder 53, and the connector 52b is installed on a surface of the circuit substrate 52a facing the Z1 direction. The circuit substrate 52a is provided with a plurality of wiring holes 52d through which wiring substrate 54i of the head chips 54 pass. Accordingly, the wiring substrate 54i is coupled to the surface of the circuit substrate 52a facing the Z1 direction through the wiring holes 52d.

The connector 52b is a coupling component electrically coupled to the circuit substrate 52a. The wiring 52c is coupled to the connector 52b. The wiring 52c is a flexible wiring substrate such as a chip on film (COF), a flexible printed circuit (FPC), or a flexible flat cable (FFC) for electrically coupling the connector 52b to the control unit 20. The circuit substrate 52a is fixed to the flow path structure 51 or the holder 53 through screwing or the like.

The holder 53 is a structure accommodating and supporting the plurality of head chips 54. The holder 53 is made of, for example, metal, ceramic, or a resin composition. The holder 53 is provided with a recess portion 53a and a plurality of wiring holes 53b. The recess portion 53a is a space open to the Z2 direction, in which the plurality of head chips 54 are disposed. Each of the plurality of wiring holes 53b is a hole through which the wiring substrates 54i of the head chips 54 pass to the substrate unit 52. The recess portion 53a may be configured with a plurality of recess portions divided for each head chip 54.

While illustration is not provided, the holder 53 includes one or a plurality of flow paths for providing supply to the two head chips 54 and also functions as a flow path structure. Accordingly, the supply flow paths of the flow path structure 51 are coupled to the head chips 54 through the flow path of the holder 53. The holder 53 may be configured with, for example, a laminate obtained by laminating a plurality of substrates in the direction along the Z axis, like the flow path structure 51. The flow path of the holder 53 may be provided as necessary or omitted. In this case, the supply flow paths of the flow path structure 51 are coupled to the head chips 54 without passing through the flow path of the holder 53.

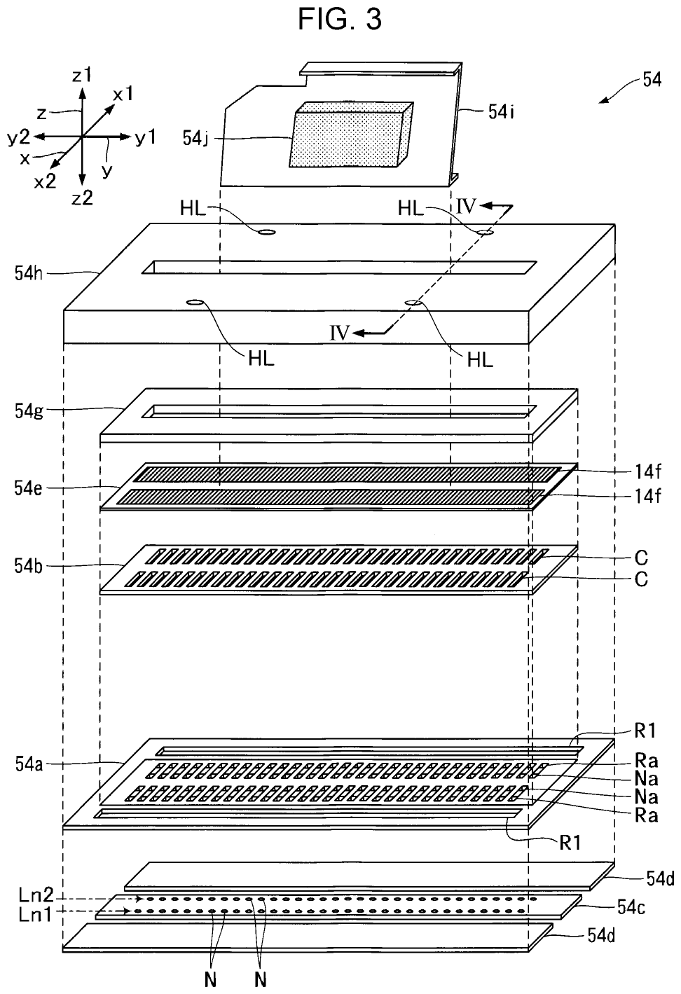

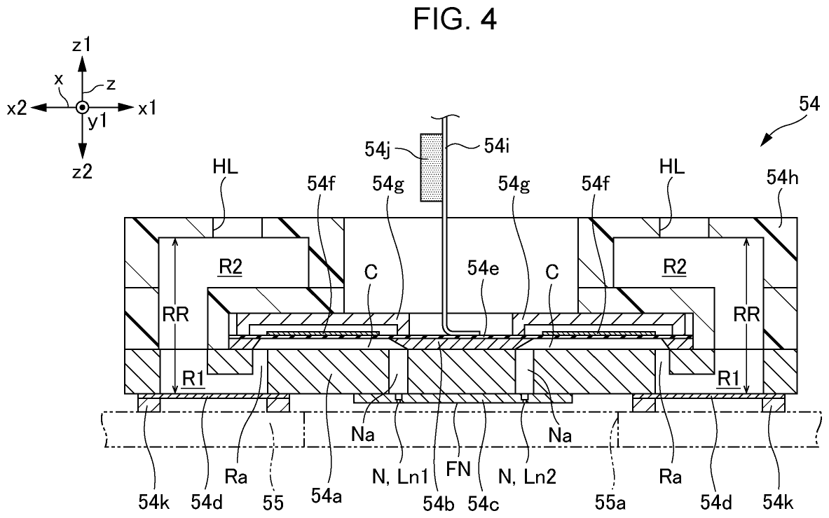

Each head chip 54 includes a nozzle surface FN for ejecting the ink. The head chip 54-1 ejects first ink that is one of the two types of ink. The head chip 54-2 ejects second ink that is the other of the two types of ink. Each head chip 54 is provided with the wiring substrate 54i. FIG. 2 schematically illustrates a configuration of each head chip 54. Details of the head chips 54 will be described later based on FIGS. 3 and 4.

The fixing plate 55 is a plate-shaped member to which the two head chips 54 and the holder 53 are fixed, and includes exposed opening portions 55a-1 and 55a-2. The exposed opening portion 55a-1 is an example of a “first exposed opening portion” and exposes a plurality of nozzles N of the head chip 54-1 outward. The exposed opening portion 55a-2 is an example of a “second exposed opening portion” and exposes a plurality of nozzles N of the head chip 54-2 outward. The fixing plate 55 is disposed in a state where the two head chips 54 are sandwiched between the fixing plate 55 and the holder 53, and each head chip 54 and the holder 53 are fixed through an adhesive or the like. The head chips 54-1 and 54-2 are fixed to the fixing plate 55. Hereinafter, each of the exposed opening portions 55a-1 and 55a-2 may be referred to as an exposed opening portion 55a without distinction therebetween.

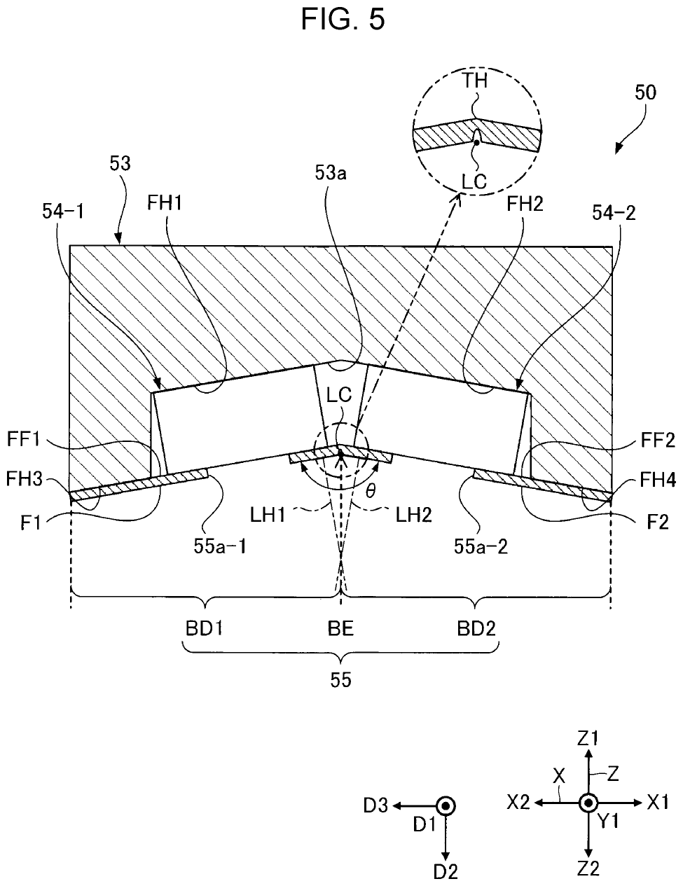

For example, the fixing plate 55 is made of a metal material such as stainless steel, titanium, and a magnesium alloy. The fixing plate 55 is bent to set installation postures of the head chip 54-1 and the head chip 54-2 to be different from each other. This point will be described later based on FIGS. 5 to 7.

### 1-3. Configuration of Head Chip

FIG. 3 is an exploded perspective view of the head chip 54. FIG. 4 is a cross-sectional view of the head chip 54. FIG. 4 is a cross-sectional view of the head chip 54 taken along line IV-IV in FIG. 3. In the present embodiment, the head chips 54-1 and 54-2 have common configurations, and each of the head chips 54-1 and 54-2 has the configuration described below.

Hereinafter, an x axis, a y axis, and a z axis intersecting with each other will be appropriately used for convenience of description of a position, a direction, and the like in the head chip 54. The x axis, the y axis, and the z axis are local coordinates with reference to the head chip 54. Hereinafter, one direction along the x axis will be referred to as an x1 direction, and a direction opposite to the x1 direction will be referred to as an x2 direction. Similarly, directions opposite to each other along the y axis will be referred to as a y1 direction and a y2 direction. Directions opposite to each other along the z axis will be referred to as a z1 direction and a z2 direction. In the present embodiment, as will be described later, in a state where the head chip 54 is installed on the fixing plate 55, the y axis is parallel to the Y axis, the x axis is inclined with respect to the X axis, and the z axis is inclined with respect to the Z axis. The y axis may be inclined with respect to the Y axis.

As illustrated in FIGS. 3 and 4, the head chip 54 includes the plurality of nozzles N arranged in a direction along the y axis. The plurality of nozzles N are divided into a first row Ln1 and a second row Ln2 arranged at an interval in a direction along the x axis. Each of the first row Ln1 and the second row Ln2 is a set of a plurality of nozzles N linearly arranged in the direction along the y axis. While the head chip 54 of the present embodiment includes two nozzle rows in which the plurality of nozzles N are arranged in the direction along the y axis, the present disclosure is not limited to this, and the number of nozzle rows may be one or three or more.

The head chip 54 has a substantially symmetric configuration about the direction along the x axis. Positions of the plurality of nozzles N of the first row Ln1 and positions of the plurality of nozzles N of the second row Ln2 in the direction along the y axis may match or differ from each other. FIGS. 3 and 4 illustrate a configuration in which the positions of the plurality of nozzles N of the first row Ln1 and the positions of the plurality of nozzles N of the second row Ln2 in the direction along the y axis match.

As illustrated in FIGS. 3 and 4, the head chip 54 includes a flow path substrate 54a, a pressure chamber substrate 54b, a nozzle plate 54c, a vibration absorber 54d, a vibration plate 54e, a plurality of piezoelectric elements 54f, a protective plate 54g, a case 54h, the wiring substrate 54i, and a drive circuit 54j.

The flow path substrate 54a and the pressure chamber substrate 54b are laminated in this order in the z1 direction and form a flow path for supplying the ink to the plurality of nozzles N. The vibration plate 54e, the plurality of piezoelectric elements 54f, the protective plate 54g, the case 54h, the wiring substrate 54i, and the drive circuit 54j are installed in a region positioned in the z1 direction of a laminate consisting of the flow path substrate 54a and the pressure chamber substrate 54b. Meanwhile, the nozzle plate 54c and the vibration absorber 54d are installed in a region positioned in the z2 direction of the laminate. Each element of the head chip 54 is schematically a plate-shaped member elongated in the y direction, and the elements are joined to each other through, for example, an adhesive. Hereinafter, each element of the head chip 54 will be described in order.

The nozzle plate 54c is a plate-shaped member including the plurality of nozzles N of each of the first row Ln1 and the second row Ln2. Accordingly, the head chip 54 includes the plurality of nozzles N for ejecting the liquid. Each of the plurality of nozzles N is a through hole through which the ink passes, and as will be described later, ejects the ink based on a change in a pressure of a pressure chamber C caused by deformation of the vibration plate 54e made by driving the piezoelectric elements 54f. A surface of the nozzle plate 54c facing the z2 direction is the nozzle surface FN. The nozzle plate 54c is manufactured by, for example, processing a silicon monocrystalline substrate using a semiconductor manufacturing technique using a processing technique such as dry etching or wet etching. Other known methods and materials may be appropriately used for manufacturing the nozzle plate 54c. A cross-sectional shape of the nozzle is typically a circular shape, but is not limited to this and may be a non-circular shape such as a polygonal shape or an elliptical shape.

The flow path substrate 54a is provided with a flow path R1, a plurality of supply flow paths Ra, and a plurality of communication flow paths Na for each of the first row Ln1 and the second row Ln2. The flow path R1 is an elongated opening extending in the direction along the y axis in a plan view in a direction along the z axis. Each supply flow path Ra and each communication flow path Na are through holes formed for each nozzle N. Each supply flow path Ra communicates with the flow path R1.

The pressure chamber substrate 54b is a plate-shaped member provided with a plurality of pressure chambers C called cavities for each of the first row Ln1 and the second row Ln2. The plurality of pressure chambers C are arranged in the direction along the y axis. Each pressure chamber C is an elongated space formed for each nozzle N and extending in the direction along the x axis in a plan view. Like the nozzle plate 54c, each of the flow path substrate 54a and the pressure chamber substrate 54b is manufactured by, for example, processing a silicon monocrystalline substrate using a semiconductor manufacturing technique. Other known methods and materials may be appropriately used for manufacturing each of the flow path substrate 54a and the pressure chamber substrate 54b.

The pressure chambers C are spaces positioned between the flow path substrate 54a and the vibration plate 54e. The plurality of pressure chambers C are arranged in the direction along the y axis for each of the first row Ln1 and the second row Ln2. The pressure chambers C communicate with each of the communication flow path Na and the supply flow path Ra. Accordingly, the pressure chambers C communicate with the nozzles N through the communication flow path Na and communicate with the flow path R1 through the supply flow path Ra.

The vibration plate 54e is disposed on a surface of the pressure chamber substrate 54b facing the z1 direction. The vibration plate 54e is a plate-shaped member that can elastically vibrate. For example, the vibration plate 54e includes a first layer and a second layer, and these layers are laminated in this order in the z1 direction. The first layer is, for example, an elastic film made of a silicon oxide (SiO₂). For example, the elastic film is formed by thermally oxidizing one surface of a silicon monocrystalline substrate. The second layer is, for example, an insulating film made of a zirconium oxide (ZrO₂). For example, the insulating film is formed by forming a zirconium layer through sputtering and thermally oxidizing the zirconium layer. The vibration plate 54e is not limited to the configuration obtained by laminating the first layer and the second layer and, for example, may be configured with a single layer or three or more layers.

The plurality of piezoelectric elements 54f corresponding to the nozzles N are disposed on a surface of the vibration plate 54e facing the z1 direction as drive elements for each of the first row Ln1 and the second row Ln2. Each piezoelectric element 54f is a passive element supplied with the drive signal to deform. Each piezoelectric element 54f has an elongated shape extending in the direction along the x axis in a plan view. The plurality of piezoelectric elements 54f are arranged to correspond to the plurality of pressure chambers C in the direction along the y axis. The piezoelectric elements 54f overlap with the pressure chambers C in a plan view.

While illustration is not provided, each piezoelectric element 54f includes a first electrode, a piezoelectric layer, and a second electrode, and these are laminated in this order in the z1 direction. One of the first electrode or the second electrode is an individual electrode disposed to be separated from each piezoelectric element 54f, and the drive signal D is applied to the individual electrode. The other electrode of the first electrode or the second electrode is a band-shaped common electrode extending continuously over the plurality of piezoelectric elements 54f in the direction along the y axis, and a predetermined reference potential is supplied to the common electrode. The piezoelectric layer is made of a piezoelectric material such as lead zirconate titanate (Pb(Zr, Ti)O₃) and, for example, has a band shape extending continuously over the plurality of piezoelectric elements 54f in the direction along the y axis. When the vibration plate 54e vibrates in line with deformation of the piezoelectric elements 54f, pressures in the pressure chambers C change, and the ink is ejected from the nozzles N. Heat generating elements that heat the ink in the pressure chambers C may be used as the drive elements instead of the piezoelectric elements 54f.

The wiring substrate 54i is mounted on the surface of the vibration plate 54e facing the z1 direction and is a mounted component for electrically coupling the control unit 20 to the head chip 54. For example, the wiring substrate 54i is a flexible wiring substrate like the wiring 52c. The drive circuit 54j for supplying a drive voltage to each piezoelectric element 54f is mounted on the wiring substrate 54i of the present embodiment. The drive circuit 54j is a circuit including a switching element that switches to supply or not supply at least a part of a waveform included in the drive signal D to the drive elements as the drive pulse based on the control signal S.

The protective plate 54g is a plate-shaped member installed on the surface of the vibration plate 54e facing the z1 direction, protects the plurality of piezoelectric elements 54f, and reinforces mechanical strength of the vibration plate 54e. The plurality of piezoelectric elements 54f are accommodated between the protective plate 54g and the vibration plate 54e.

The case 54h is a structure for storing the ink to be supplied to the plurality of pressure chambers C and defines a flow path R2. For example, the case 54h is made of a resin material. The case 54h is provided with the flow path R2 for each of the first row Ln1 and the second row Ln2. The flow path R2 is a space communicating with the flow path R1 and, together with the flow path R1, functions as a common liquid chamber RR storing the ink to be supplied to the plurality of pressure chambers C. The case 54h is provided with an inlet HL for supplying the ink to each common liquid chamber RR. Accordingly, the liquid is poured into the flow path R2 through the inlet HL. The ink in each common liquid chamber RR is supplied to the pressure chambers C through each supply flow path Ra. The head chip 54 includes the common liquid chamber RR communicating with the plurality of nozzles N. In the example illustrated in FIG. 3, the number of inlets HL provided for one common liquid chamber RR is two, but is not limited to this and may be for example, one.

The vibration absorber 54d is a flexible thin film member constituting a wall surface of the common liquid chamber RR. The vibration absorber 54d absorbs a change in a pressure of the ink in the common liquid chamber RR. A surface of the vibration absorber 54d facing the z1 direction is joined to the flow path substrate 54a through an adhesive or the like. Meanwhile, a frame body 54k is joined to a surface of the vibration absorber 54d facing the z2 direction through an adhesive or the like. The frame body 54k is a frame-shaped member along an outer periphery of the vibration absorber 54d and is fixed in contact with the fixing plate 55 through an adhesive or the like. For example, the frame body 54k is made of a metal material such as stainless steel.

### 1-4. Fixing Plate

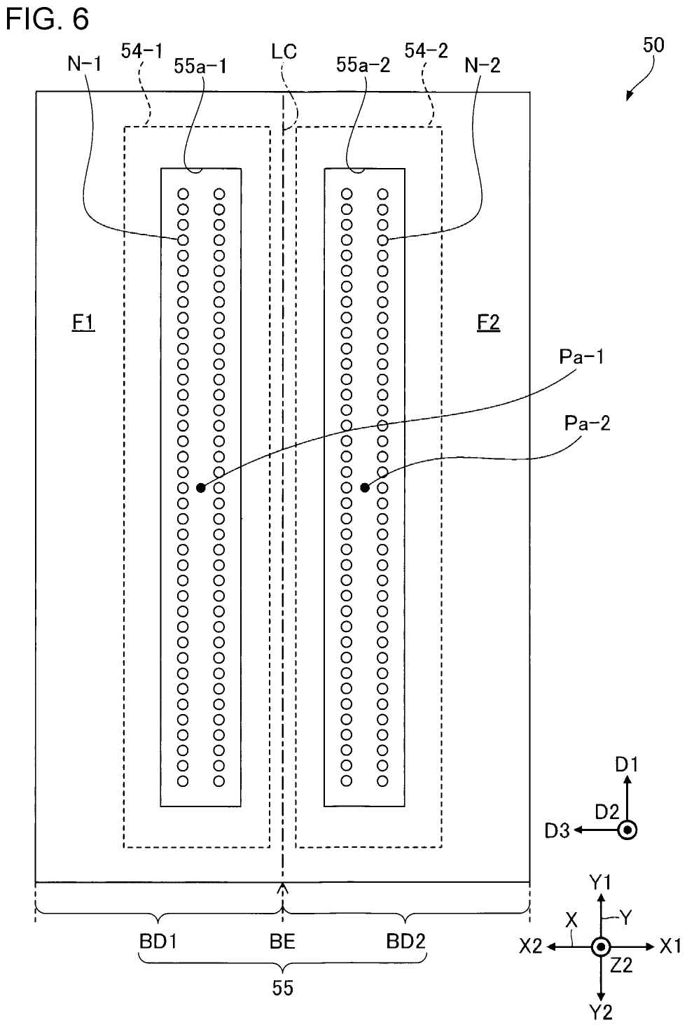

FIG. 5 is a schematic cross-sectional view of the liquid ejecting head 50 according to the first embodiment. FIG. 6 is a bottom view of the liquid ejecting head 50 according to the first embodiment. For convenience of description, FIG. 5 representatively illustrates the holder 53, the head chips 54-1 and 54-2, and the fixing plate 55 among constituents of the liquid ejecting head 50. FIG. 6 is a view of the liquid ejecting head 50 seen from the Z2 direction and illustrates a positional relationship between the head chips 54-1 and 54-2 and the fixing plate 55.

As illustrated in FIG. 5, the head chip 54-1 and the head chip 54-2 are accommodated in the recess portion 53a of the holder 53. In the example illustrated in FIG. 5, the bottom surface of the recess portion 53a includes surfaces FH1 and FH2. The surface FH1 is a surface parallel to a first fixing surface FF1 (described later), and a surface of the head chip 54-1 facing the z1 direction is disposed along the surface FH1. The surface FH1 may be in contact with or not be in contact with the surface of the head chip 54-1 facing the z1 direction. The surface FH2 is a surface parallel to a second fixing surface FF2 (described later), and a surface of the head chip 54-2 facing the z1 direction is disposed along the surface FH2. The surface FH2 may be in contact with or not be in contact with the surface of the head chip 54-2 facing the z1 direction. Since the surface FH1 is parallel to the first fixing surface FF1, flow path coupling between a flow path opening of the holder 53 (not illustrated) formed on the surface FH1 and the inlet HL provided on an upper surface (a surface on a side opposite to the nozzle surface FN) of the head chip 54-1 is facilitated. The same applies to the surface FH2 and the second fixing surface FF2.

In the present embodiment, lines normal to the surfaces FH1 and FH2 are inclined with respect to the Z axis. The present disclosure is not limited to the aspect in which the lines normal to the surfaces FH1 and FH2 are inclined with respect to the Z axis. For example, the lines normal to the surfaces FH1 and FH2 may be parallel to the Z axis.

The holder 53 is provided with surfaces FH3 and FH4 around the recess portion 53a. The surface FH3 is a surface that is inclined with respect to a plane perpendicular to the Z axis to be parallel to the first fixing surface FF1 (described later), and a first flat plate portion BD1 (described later) is joined to the surface FH3 through an adhesive or the like. The surface FH4 is a surface that is inclined with respect to a plane perpendicular to the Z axis to be parallel to the second fixing surface FF2 (described later), and a second flat plate portion BD2 (described later) is joined to the surface FH4 through an adhesive or the like.

As illustrated in FIG. 5, the fixing plate 55 includes the first flat plate portion BD1 and the second flat plate portion BD2. The first flat plate portion BD1 is a plate-shaped part that is a part of the fixing plate 55 and that includes the first fixing surface FF1 and a first surface F1. The first flat plate portion BD1 is provided with the exposed opening portion 55a-1, and the head chip 54-1 is fixed to the first fixing surface FF1 through an adhesive or the like. The first surface F1 is a surface opposite to the first fixing surface FF1. The second flat plate portion BD2 is a plate-shaped part that is a part of the fixing plate 55 and that includes the second fixing surface FF2 and a second surface F2. The second flat plate portion BD2 is provided with the exposed opening portion 55a-2, and the head chip 54-2 is fixed to the second fixing surface FF2 through an adhesive or the like. The second surface F2 is a surface opposite to the second fixing surface FF2.

As illustrated in FIG. 6, the head chip 54-1 includes a plurality of nozzles N−1 for ejecting the ink. The nozzles N−1 are the nozzles N as an example of a “first nozzle”. The exposed opening portion 55a-1 exposes the plurality of nozzles N−1 outward. The head chip 54-2 includes a plurality of nozzles N−2 for ejecting the ink. The nozzles N−2 are the nozzles N as an example of a “second nozzle”. The exposed opening portion 55a-2 exposes the plurality of nozzles N−2 outward.

The exposed opening portion 55a-1 and the exposed opening portion 55a-2 are arranged in this order in the X1 direction. The head chip 54-1 and the head chip 54-2 are arranged in this order in the X1 direction.

In the present embodiment, as illustrated in FIG. 6, the plurality of nozzles N−1 are arranged along the first direction D1, and the plurality of nozzles N−2 are arranged along the first direction D1. At a position facing the liquid ejecting head 50, the transport portion 30 transports the medium M in the first direction D1 along a surface perpendicular to the second direction D2. The first direction D1 is a direction along an intersection line LC between the first surface F1 and the second surface F2 and is the Y1 direction in the present embodiment.

As illustrated in FIG. 5, the first surface F1 and the second surface F2 are caused to face different directions from each other by bending the fixing plate 55. In a view from the first direction D1, an angle θ formed between the first surface F1 and the second surface F2 is less than 180 degrees.

Accordingly, lines normal to the first surface F1 and the second surface F2 are not parallel to each other and face directions that come closer to each other. Thus, in the view from the first direction D1 along the intersection line LC between the first surface F1 and the second surface F2, a first half-line LH1 extending in a direction perpendicular to the first surface F1 from the first surface F1 and a second half-line LH2 extending in a direction perpendicular to the second surface F2 from the second surface F2 intersect with each other. The first half-line LH1 is a half-line extending from the first surface F1 in a direction from the first fixing surface FF1 to the first surface F1. The second half-line LH2 is a half-line extending from the second surface F2 in a direction from the second fixing surface FF2 to the second surface F2. A direction normal to the first surface F1 substantially matches an ejection direction of the liquid of the head chip 54-1, and a direction normal to the second surface F2 substantially matches an ejection direction of the liquid of the head chip 54-2.

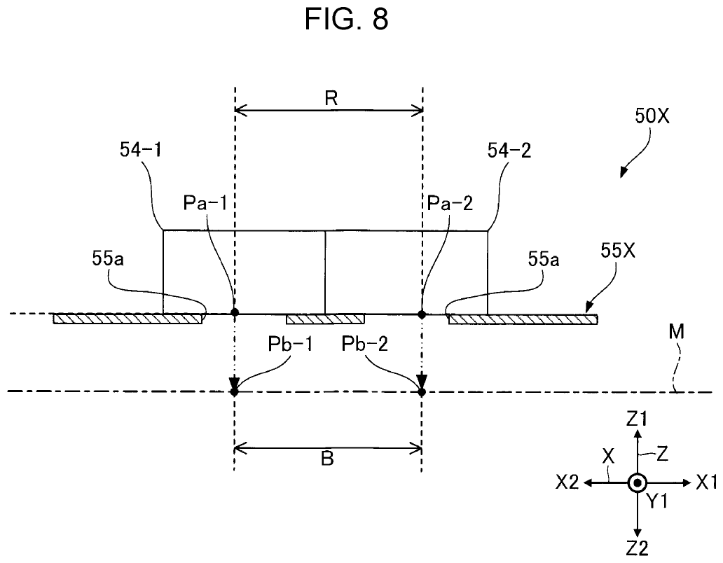

In a liquid ejecting head 50X in the related art illustrated in FIG. 8, the head chips 54-1 and 54-2 are fixed to the same flat plate part of a fixing plate 55X of which an in-plane direction is a direction perpendicular to the Z axis. Thus, the liquid is ejected to the same Z2 direction from both of the head chips 54-1 and 54-2. Accordingly, when a dot is formed by causing the liquid to land at the same position in a direction along the X axis on the medium M from the head chips 54-1 and 54-2, a difference in landing time occurs between landing of the liquid ejected from one of the head chips 54-1 and 54-2 at a predetermined position in the direction along the X axis and landing of the liquid ejected from the other at the predetermined position. This difference in the landing time corresponds to a length of time required for the carriage to move through an interval between the nozzles N−1 of the head chip 54-1 and the nozzles N−2 of the head chip 54-2 in the direction along the X axis that is a main scanning direction of the carriage, in the liquid ejecting head 50X according to the related art.

Meanwhile, in the present embodiment, by setting the angle θ to be less than 180 degrees, a landing position of the liquid from the head chip 54-1 and a landing position of the liquid from the head chip 54-2, ejected at the same timing, can be brought closer to each other. Consequently, the difference in the landing time when a dot is formed by causing the liquid to land at the same position in the direction along the X axis on the medium M from the head chip 54-1 and the head chip 54-2 can be reduced.

In the present embodiment, the plurality of nozzles N−1 are arranged in the first direction D1, and the plurality of nozzles N−2 are arranged in the first direction D1. Thus, the landing position of the liquid from the head chip 54-1 and the landing position of the liquid from the head chip 54-2 can be brought closer to each other for the plurality of nozzles N extending in a range in the first direction D1.

As described above, at the position facing the liquid ejecting head 50, the transport portion 30 transports the medium M in the first direction D1 along the surface perpendicular to the second direction D2 that is a laminating direction of the plurality of substrates of the flow path structure 51. Thus, in the serial system, the landing position of the liquid from the head chip 54-1 and the landing position of the liquid from the head chip 54-2 can be brought closer to each other.

Accordingly, a combination of ink that preferably has a small difference in the landing time is suitable as a combination of types of the liquid used for the head chip 54-1 and the head chip 54-2, that is, a combination of the first ink and the second ink. For example, in the case of a combination of reactive liquid that is an example of pre-treatment liquid, and a water-based resin that is an example of pigment ink or clear ink, a time required for the ink to coagulate is short. Thus, spreading of the ink can be reduced by reducing bleeding of the ink. The reactive liquid is liquid containing a coagulator that coagulates pigment, a resin, and the like contained in an ink composition. Examples of the coagulator include a polyvalent metal salt, a cationic polymer, a cationic surfactant, and an organic acid. One type of the coagulators may be used alone, or two or more types of the coagulators may be used in combination with each other. The reactive liquid may be used as post-treatment liquid to be ejected after the pigment ink or the clear ink. In the case of a combination of color ink of different colors, color tones can be improved.

Bringing the landing position of the liquid from the head chip 54-1 and the landing position of the liquid from the head chip 54-2 closer to each other also achieves an advantage such that error in transporting the medium is unlikely to affect printing quality.

Furthermore, an interval between upper surfaces (surfaces on a side opposite to surfaces on which the fixing plate 55 is installed) of the head chip 54-1 and the head chip 54-2 can be increased. This achieves an advantage such that the head chips 54 are easily held in aligning the head chip 54-1 and the head chip 54-2 on the fixing plate 55 after the fixing plate 55 is bent. Alignment for adjusting positions of the plurality of head chips 54 with respect to the fixing plate 55 may be performed while checking the positions of the head chips 54 with respect to the fixing plate 55 using an optical device such as a camera. Bending of the fixing plate 55 may be performed after aligning the plurality of head chips 54. In this case, the plurality of head chips 54 can be aligned in a state where the fixing plate 55 is a flat plate. Thus, alignment is facilitated.

The angle θ formed between the first surface F1 and the second surface F2 is a dihedral angle between the first surface F1 and the second surface F2 in a range not passing through the first fixing surface FF1 and the second fixing surface FF2. When the first flat plate portion BD1 and the second flat plate portion BD2 are not adjacent to each other as in a modification example of a second embodiment (described later), the angle θ is a dihedral angle between the first flat plate portion BD1 and the second flat plate portion BD2 when the first flat plate portion BD1 and the second flat plate portion BD2 are virtually disposed to match positions of end portions of the first fixing surface FF1 and the second fixing surface FF2 closer to each other in a view from a direction along the intersection line LC, or is an angle formed between planes extending from each of the first surface F1 and the second surface F2. The angle θ formed between the first surface F1 and the second surface F2 corresponds to an angle obtained by subtracting an angle formed between the first fixing surface FF1 and the second fixing surface FF2 from 360 degrees.

The angle θ may be less than 180 degrees and is preferably 90 degrees or more, more preferably 135 degrees or more, and further preferably 170 degrees or more. The angle θ is preferably 179 degrees or less, more preferably 177 degrees or less, and further preferably 175 degrees or less. Accordingly, the landing position of the liquid from the head chip 54-1 and the landing position of the liquid from the head chip 54-2 can be suitably brought closer to each other.

The fixing plate 55 is bent in a direction in which the ejection direction of the head chip 54-1 and the ejection direction of the head chip 54-2 come closer to each other. Thus, the fixing plate 55 includes a bent portion BE. The bent portion BE is a bent part between the first flat plate portion BD1 and the second flat plate portion BD2. The first flat plate portion BD1 and the second flat plate portion BD2 are adjacent to each other through the bent portion BE. Accordingly, the landing position of the liquid from the head chip 54-1 and the landing position of the liquid from the head chip 54-2 can be brought closer to each other, and size reduction of the liquid ejecting head 50 can be achieved.

As illustrated in FIG. 5, the bent portion BE includes a thin portion TH having a smaller thickness than the first flat plate portion BD1. Accordingly, the bent portion BE can be easily formed. Restoring force (spring back) caused by bending in the bent portion BE can be reduced. Consequently, misalignment between the head chip 54-1 and the head chip 54-2 can be reduced.

From a viewpoint of facilitating formation of the bent portion BE, the thin portion TH preferably extends in the first direction D1. The thin portion TH may continuously extend from an end of the fixing plate 55 in the first direction D1 to an end of the fixing plate 55 in a direction opposite to the first direction D1 along the first direction D1, or may intermittently extend like a broken line. The thin portion TH is formed by, for example, providing a groove such as a V notch on at least one surface of the bent portion BE. The thin portion TH may be provided or omitted, as necessary.

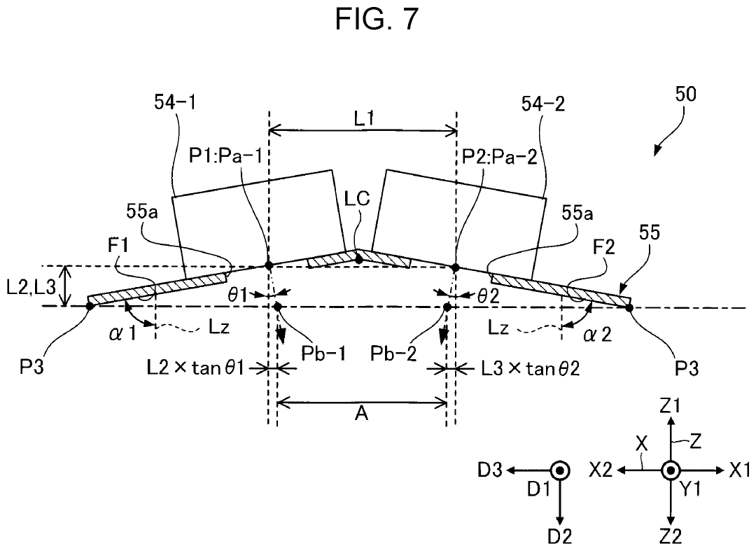

FIG. 7 is a descriptive view of the liquid ejecting head 50 according to the first embodiment. For convenience of description, FIG. 7 representatively illustrates the head chips 54-1 and 54-2 and the fixing plate 55 seen from the Y1 direction among the constituents of the liquid ejecting head 50.

As described above, the plurality of head chips 54 are disposed in the second direction D2 with respect to the flow path structure 51. As illustrated in FIG. 7, in the view from the first direction D1, a center position Pa−1 of the plurality of nozzles N−1 is a first position P1. In the view from the first direction D1, a center position Pa−2 of the plurality of nozzles N−2 is a second position P2. An end of the fixing plate 55 in the second direction D2 is positioned at a third position P3.

A distance between the first position P1 and the second position P2 in the third direction D3 orthogonal to both of the first direction D1 and the second direction D2 is denoted by L1. A distance between the first position P1 and the third position P3 in the second direction D2 is denoted by L2. A distance between the second position P2 and the third position P3 in the second direction D2 is denoted by L3. An angle formed between a straight line extending in the second direction D2 and the first half-line LH1 in the view from the first direction D1 is denoted by θ1. An angle formed between the straight line extending in the second direction D2 and the second half-line LH2 in the view from the first direction D1 is denoted by θ2. Then, L1−(L2×tan θ1+L3×tan θ2)<R is satisfied. In the present embodiment, the third direction D3 is the X2 direction. Each of θ1 and θ2 is an acute angle.

As illustrated in FIG. 8 described later, when the head chip 54-1 and the head chip 54-2 are disposed adjacent to each other in an arrangement direction to be in contact with each other, and each nozzle surface FN of the head chip 54-1 and the head chip 54-2 is disposed to face the same direction, R denotes a length of a line segment linking the center position Pa−1 of the plurality of nozzles N−1 in the arrangement direction and the center position Pa−2 of the plurality of nozzles N−2 in the arrangement direction. In FIG. 8, the arrangement direction is the direction along the X axis.

By satisfying the relationship of L1−(L2×tan θ1+L3×tan θ2)<R, a small difference in the landing time between the liquid from the head chip 54-1 and the liquid from the head chip 54-2 can be secured. When a distance between a landing position Pb−1 of the ink on the medium M from the head chip 54-1 and a landing position Pb−2 of the ink on the medium M from the head chip 54-2 when a distance between the head chips 54 and the medium M is minimized is denoted by A, a relationship of A=L1−(L2×tan θ1+L3×tan θ2) is satisfied. Thus, a relationship of A<R is satisfied. The distance A is decreased as the distances L2 and L3 are increased. However, it is required to satisfy a relationship of L1>(L2×tan θ1+L3×tan θ2).

In the view from the first direction D1, the first position P1 is a midpoint of a line segment linking the nozzle N−1 positioned at one end and the nozzle N−1 positioned at the other end in a direction along the first surface F1 and orthogonal to the first direction D1 among the plurality of nozzles N−1, and corresponds to a center position of a nozzle group of the plurality of nozzles N−1.

In the view from the first direction D1, the second position P2 is a midpoint of a line segment linking the nozzle N−2 positioned at one end and the nozzle N−2 positioned at the other end in a direction along the second surface F2 and orthogonal to the first direction D1 among the plurality of nozzles N−2, and corresponds to a center position of a nozzle group of the plurality of nozzles N−2. When the head chip 54-1 includes only one nozzle row in which the plurality of nozzles N−1 are arranged in a direction along the Y axis, the first position P1 corresponds to the center position of any nozzle N−1. The same applies to the second position P2.

In the example illustrated in FIG. 7, in the view from the first direction D1, an angle α1 formed between a straight line Lz extending in the second direction D2 and the first surface F1 is equal to an angle α2 formed between the straight line Lz extending in the second direction D2 and the second surface F2. In other words, in the view from the first direction D1, an angle formed between the straight line Lz and the first half-line LH1 is equal to an angle formed between the straight line Lz and the second half-line LH2. Accordingly, assemblability of the liquid ejecting head 50 can be increased compared to an aspect in which the angles α1 and α2 are different from each other. Equal distances from the head chip 54-1 and the head chip 54-2 to the medium M can be achieved. Thus, a position of the liquid from the head chip 54-1 and the head chip 54-2 to the medium M can be easily adjusted. The angles α1 and α2 may be different from each other.

FIG. 8 is a descriptive view of the liquid ejecting head 50X in the related art. The liquid ejecting head 50X is configured in the same manner as the liquid ejecting head 50 except that the ejection directions of the head chips 54-1 and 54-2 are parallel to the Z axis. The liquid ejecting head 50X includes the fixing plate 55X instead of the fixing plate 55. The fixing plate 55X is configured in the same manner as the fixing plate 55 except that the whole fixing plate 55X has a shape along a plane.

As illustrated in FIG. 8, when the head chip 54-1 and the head chip 54-2 are disposed adjacent to each other in the arrangement direction to be in contact with each other, and each nozzle surface FN of the head chip 54-1 and the head chip 54-2 is disposed to face the same direction, a distance between the center position Pa−1 and the center position Pa−2 in the arrangement direction is the length R.

The liquid ejecting head 50X satisfies a relationship of B=R. B denotes a distance between the landing position Pb−1 of the ink on the medium M from the head chip 54-1 and the landing position Pb−2 of the ink on the medium M from the head chip 54-2 in the arrangement direction. In the liquid ejecting head 50X in which the head chips 54-1 and 54-2 are arranged in the same flat plate part, the distance B cannot be physically set to be smaller than the distance R. In practice, it is not easy to manufacture the liquid ejecting head 50X in which the head chips 54-1 and 54-2 are arranged to be in contact with each other in the same flat plate part. Thus, in the liquid ejecting head in which the head chips 54-1 and 54-2 are arranged in the same flat plate part in the related art, a relationship of B>R is established, and it is difficult to reduce the difference in the landing time.

Meanwhile, in the liquid ejecting head 50, the relationship of A<R can be easily satisfied by bending the fixing plate. Thus, the distance A can be reduced compared to that in the liquid ejecting head 50X.

### 1-A. Modification Example 1 of First Embodiment

Hereinafter, the present modification example will be described. In the embodiment illustrated below, elements having the same effects and functions as those of the first embodiment will be designated by the reference numerals used in the description of the first embodiment, and each of the elements will not be described in detail, as appropriate.

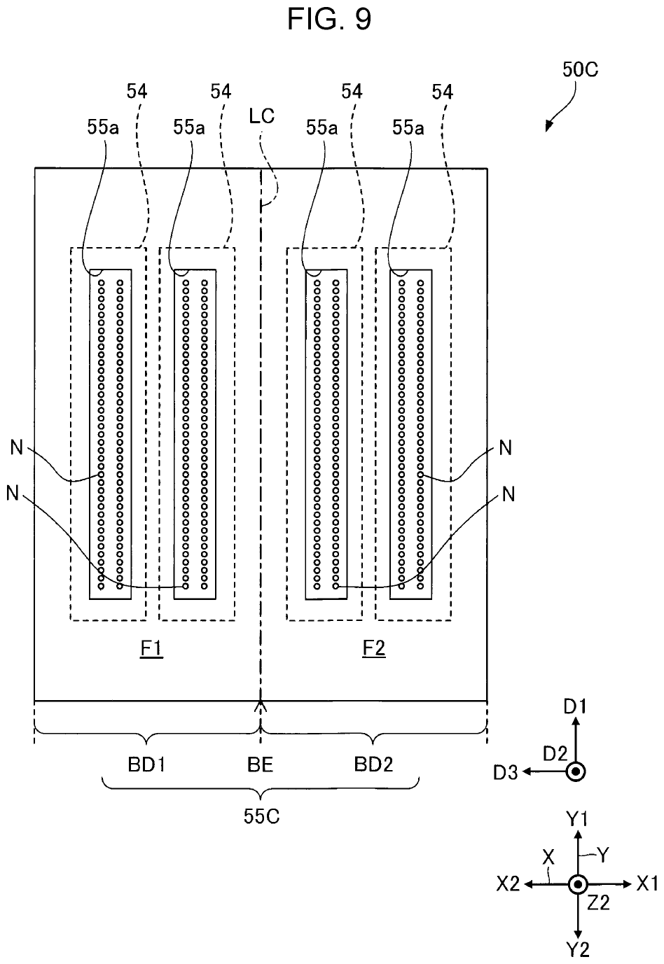

FIG. 9 is a bottom view of a liquid ejecting head 50C according to the present modification example. The liquid ejecting head 50C is configured in the same manner as the liquid ejecting head 50 of the first embodiment except for having a configuration with a different number and disposition of the head chips 54. The liquid ejecting head 50C includes a fixing plate 55C instead of the fixing plate 55 of the first embodiment and includes four head chips 54. The fixing plate 55C is configured in the same manner as the fixing plate 55 of the first embodiment except for having a different number and disposition of the exposed opening portions 55a.

In the present modification example, while illustration is not provided, at a position facing the liquid ejecting head 50C, the transport portion 30 transports the medium M in the first direction D1 along a surface perpendicular to the second direction D2, and the moving mechanism 40 causes the liquid ejecting head 50C to reciprocate along an axis along the third direction D3, as in the first embodiment. That is, an aspect of applying the liquid ejecting head 50C (described later) to the serial system is illustrated. The Y1 direction corresponds to the first direction D1, the Z2 direction corresponds to the second direction D2, and the X2 direction corresponds to the third direction D3. While illustration is not provided, in the present modification example, the first surface F1 and the second surface F2 are caused to face different directions from each other by bending the fixing plate 55C, and in the view from the first direction D1, the angle θ formed between the first surface F1 and the second surface F2 is less than 180 degrees, as in the first embodiment.

In the fixing plate 55C, the first flat plate portion BD1 is provided with two exposed opening portions 55a arranged in the direction along the X axis, and two head chips 54 corresponding to the two exposed opening portions 55a are fixed to the first fixing surface FF1 through an adhesive or the like. Any of the two exposed opening portions 55a is an example of the “first exposed opening portion”, and the head chip 54 corresponding to the first exposed opening portion out of the two head chips 54 is an example of the “first head chip”.

Meanwhile, in the fixing plate 55C, the second flat plate portion BD2 is provided with two exposed opening portions 55a arranged in the direction along the X axis, and two head chips 54 corresponding to the two exposed opening portions 55a are fixed to the second fixing surface FF2 through an adhesive or the like. Any of the two exposed opening portions 55a is an example of the “second exposed opening portion”, and the head chip 54 corresponding to the second exposed opening portion out of the two head chips 54 is an example of the “second head chip”.

The number of head chips 54 fixed to each of the first flat plate portion BD1 and the second flat plate portion BD2 may be two or more. In the present modification example, the plurality of nozzles N of each head chip 54 are arranged along the first direction D1. A combination of types of the liquid used for the head chip 54 fixed to the first flat plate portion BD1 and the head chip 54 fixed to the second flat plate portion BD2 is preferably the same as the combination of the types of the liquid used for the head chip 54-1 and the head chip 54-2 of the first embodiment, that is, the combination of the first ink and the second ink.

The present modification example achieves the same effect as the first embodiment.

### 1-B. Modification Example 2 of First Embodiment

Hereinafter, the present modification example will be described. In the embodiment illustrated below, elements having the same effects and functions as those of the first embodiment will be designated by the reference numerals used in the description of the first embodiment, and each of the elements will not be described in detail, as appropriate.

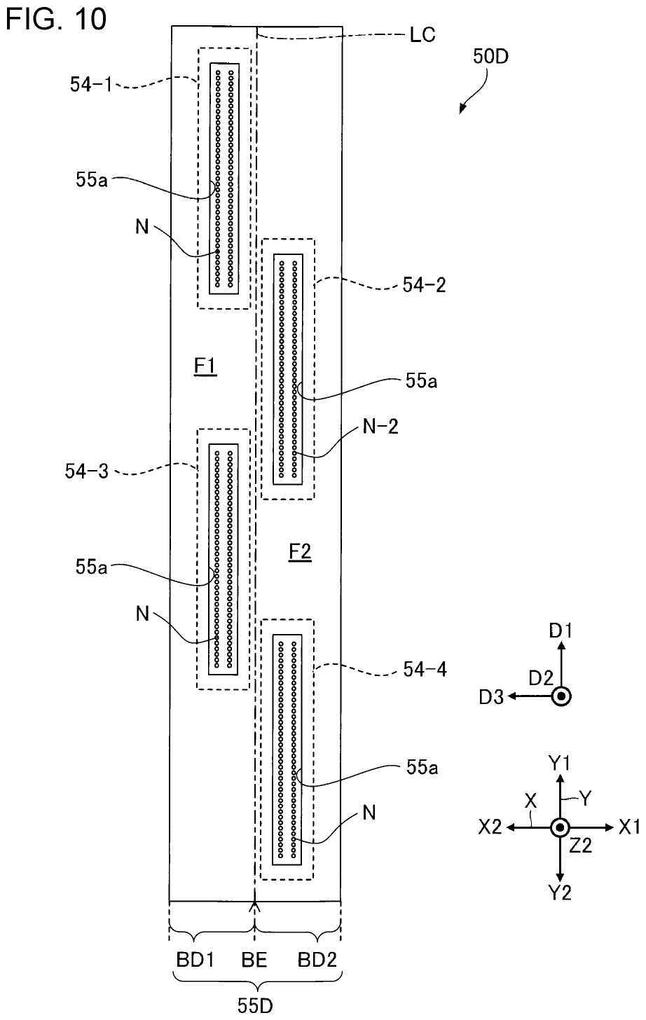

FIG. 10 is a bottom view of a liquid ejecting head 50D according to the present modification example. The liquid ejecting head 50D is configured in the same manner as the liquid ejecting head 50 of the first embodiment except for having a configuration with a different number and disposition of the head chips 54. The liquid ejecting head 50D includes a fixing plate 55D instead of the fixing plate 55 of the first embodiment and includes four head chips 54. The fixing plate 55D is configured in the same manner as the fixing plate 55 of the first embodiment except for having a different number and disposition of the exposed opening portions 55a.

While illustration is not provided, at a position facing the liquid ejecting head 50D, the transport portion 30 transports the medium M in the first direction D1 along a surface perpendicular to the second direction D2. The moving mechanism 40 causes the liquid ejecting head 50D to reciprocate along the axis along the third direction D3. That is, the present modification example illustrates an aspect of applying the liquid ejecting head 50D (described later) to the serial system. The Y1 direction corresponds to the first direction D1, the Z2 direction corresponds to the second direction D2, and the X2 direction corresponds to the third direction D3. While illustration is not provided, in the present modification example, the first surface F1 and the second surface F2 are caused to face different directions from each other by bending the fixing plate 55D, and in the view from the first direction D1, the angle θ formed between the first surface F1 and the second surface F2 is less than 180 degrees, as in the first embodiment.

In the fixing plate 55D, the first flat plate portion BD1 is provided with two exposed opening portions 55a arranged in the direction along the Y axis, and two head chips 54-1 and 54-3 corresponding to the two exposed opening portions 55a are fixed to the first fixing surface FF1 through an adhesive or the like. Any of the two exposed opening portions 55a is an example of the “first exposed opening portion”, and the head chip 54 corresponding to the first exposed opening portion out of the two head chips 54-1 and 54-3 is an example of the “first head chip”.

Meanwhile, in the fixing plate 55D, the second flat plate portion BD2 is provided with two exposed opening portions 55a arranged in the direction along the Y axis, and two head chips 54-2 and 54-4 corresponding to the two exposed opening portions 55a are fixed to the second fixing surface FF2 through an adhesive or the like. Any of the two exposed opening portions 55a is an example of the “second exposed opening portion”, and the head chip 54 corresponding to the second exposed opening portion out of the two head chips 54-2 and 54-4 is an example of the “second head chip”.

As illustrated in FIG. 10, in the present modification example, the plurality of nozzles N of each head chip 54 are arranged along the first direction D1. The four head chips 54-1, 54-2, 54-3, and 54-4 are arranged in this order in a staggered pattern in the Y2 direction. In two adjacent head chips 54 among the four head chips 54, for example, in the head chip 54-1 and the head chip 54-2, a part of the nozzle row of the head chip 54-1 and a part of the nozzle row of the head chip 54-2 are disposed to overlap with each other in a view from the direction along the X axis. In this disposition of the head chips 54, when the same types of the ink are used as a combination of types of the liquid used for the head chips 54-1 and 54-3 fixed to the first flat plate portion BD1 and for the head chips 54-2 and 54-4 fixed to the second flat plate portion BD2, an effective printing width, in the direction along the Y axis, with which printing can be performed on the medium M in scanning the liquid ejecting head 50D once in the X1 direction or the X2 direction via the moving mechanism 40 can be increased.

In the present modification example, as described above, by bending the fixing plate 55D, a landing position of the ink ejected from the head chips 54-1 and 54-3 and a landing position of the same ink ejected from the head chips 54-2 and 54-4 can be brought closer to each other. This achieves an advantage such that error in transporting the medium is unlikely to affect the printing quality, as in the first embodiment.

Even when a gap between the adjacent head chips 54 in the direction along the X axis is reduced, an advantage such that the head chips 54 are easily held in aligning the head chips 54 on the fixing plate 55D after bending the fixing plate 55D is achieved, as in the first embodiment.

### 1-C. Modification Example 3 of First Embodiment

Hereinafter, the present modification example will be described. In the embodiment illustrated below, elements having the same effects and functions as those of the first embodiment will be designated by the reference numerals used in the description of the first embodiment, and each of the elements will not be described in detail, as appropriate.

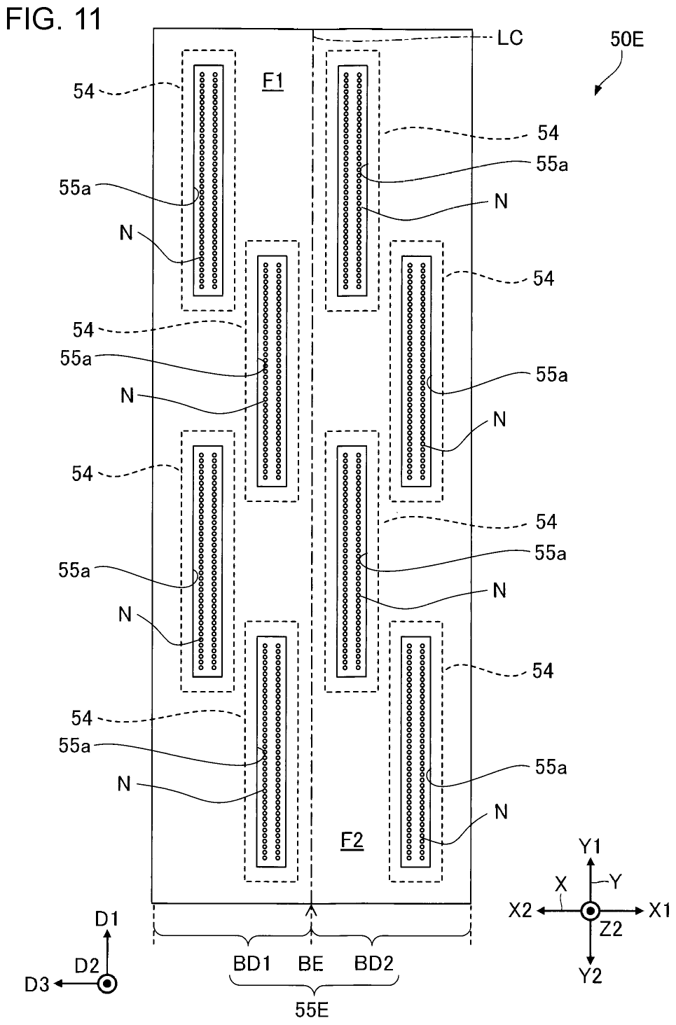

FIG. 11 is a bottom view of a liquid ejecting head 50E according to the present modification example. The liquid ejecting head 50E is configured in the same manner as the liquid ejecting head 50 of the first embodiment except for having a configuration with a different number and disposition of the head chips 54. The liquid ejecting head 50E includes a fixing plate 55E instead of the fixing plate 55 of the first embodiment and includes eight head chips 54. The fixing plate 55E is configured in the same manner as the fixing plate 55 of the first embodiment except for having a different number and disposition of the exposed opening portions 55a.

While illustration is not provided, at a position facing the liquid ejecting head 50E, the transport portion 30 transports the medium M in the first direction D1 along a surface perpendicular to the second direction D2. The moving mechanism 40 causes the liquid ejecting head 50E to reciprocate along the axis along the third direction D3. That is, the present modification example illustrates an aspect of applying the liquid ejecting head 50E (described later) to the serial system. The Y1 direction corresponds to the first direction D1, the Z2 direction corresponds to the second direction D2, and the X2 direction corresponds to the third direction D3. While illustration is not provided, in the present modification example, the first surface F1 and the second surface F2 are caused to face different directions from each other by bending the fixing plate 55E, and in the view from the first direction D1, the angle θ formed between the first surface F1 and the second surface F2 is less than 180 degrees, as in the first embodiment.

In the fixing plate 55E, the first flat plate portion BD1 is provided with four exposed opening portions 55a arranged in a staggered pattern in the directions along the X axis and the Y axis, and four head chips 54 corresponding to the four exposed opening portions 55a are fixed to the first fixing surface FF1 through an adhesive or the like. Any of the four exposed opening portions 55a is an example of the “first exposed opening portion”, and the head chip 54 corresponding to the first exposed opening portion among the four head chips 54 is an example of the “first head chip”.

Meanwhile, in the fixing plate 55E, the second flat plate portion BD2 is provided with four exposed opening portions 55a arranged in a staggered pattern in the directions along the X axis and the Y axis, and four head chips 54 corresponding to the four exposed opening portions 55a are fixed to the second fixing surface FF2 through an adhesive or the like. Any of the four exposed opening portions 55a is an example of the “second exposed opening portion”, and the head chip 54 corresponding to the second exposed opening portion among the four head chips 54 is an example of the “second head chip”.

In the present modification example, the plurality of nozzles N of each head chip 54 are arranged along the first direction D1. As illustrated in FIG. 11, a layout of the four head chips 54 arranged in each of the first flat plate portion BD1 and the second flat plate portion BD2 is substantially the same as a layout of the four head chips 54 arranged in the fixing plate 55D, described in Modification Example 2 of the first embodiment. In this disposition of the head chips 54, a combination of types of the liquid used for the head chip 54 fixed to the first flat plate portion BD1 and the head chip 54 fixed to the second flat plate portion BD2 is preferably the same as the combination of the types of the liquid used for the head chip 54-1 and the head chip 54-2 of the first embodiment, that is, the combination of the first ink and the second ink.

The present modification example having the above configuration can achieve the same effect as the first embodiment.

### 1-D. Modification Example 4 of First Embodiment

Hereinafter, the present modification example will be described. In the embodiment illustrated below, elements having the same effects and functions as those of the first embodiment will be designated by the reference numerals used in the description of the first embodiment, and each of the elements will not be described in detail, as appropriate.

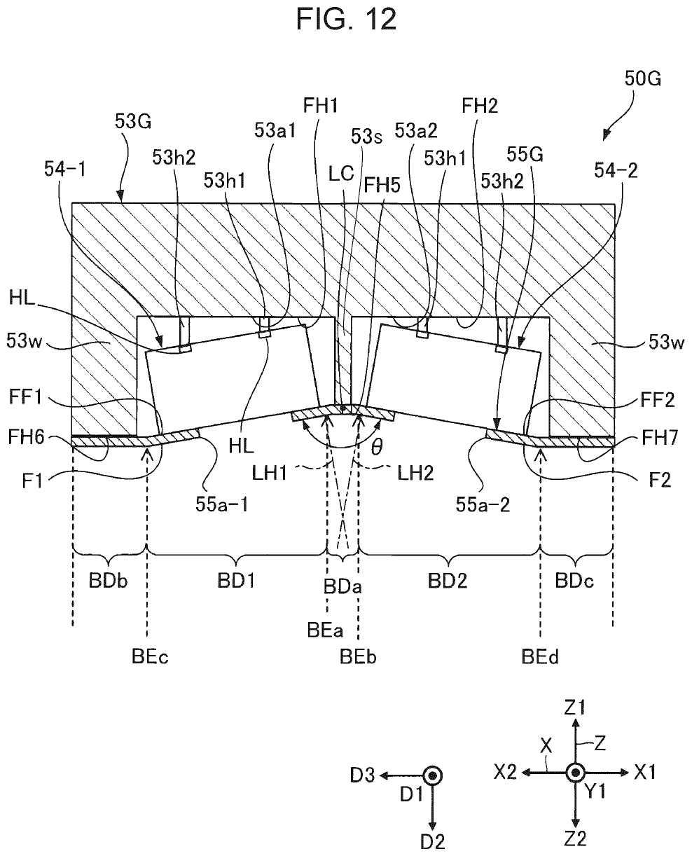

FIG. 12 is a schematic cross-sectional view of a liquid ejecting head 50G according to the present modification example. The liquid ejecting head 50G is configured in the same manner as the liquid ejecting head 50 of the first embodiment except for including a holder 53G instead of the holder 53 and including a fixing plate 55G instead of the fixing plate 55.

While illustration is not provided, at a position facing the liquid ejecting head 50G, the transport portion 30 transports the medium M in the first direction D1 along a surface perpendicular to the second direction D2. The moving mechanism 40 causes the liquid ejecting head 50G to reciprocate along the axis along the third direction D3. That is, the present modification example illustrates an aspect of applying the liquid ejecting head 50G (described later) to the serial system. The Y1 direction corresponds to the first direction D1, the 22 direction corresponds to the second direction D2, and the X2 direction corresponds to the third direction D3.

The holder 53G is configured in the same manner as the holder 53 of the first embodiment except that a surface FH5 is added by including recess portions 53a1 and 53a2 instead of the recess portion 53a, and surfaces FH6 and FH7 are included instead of the surfaces FH3 and FH4.

The holder 53G includes an outer peripheral wall portion 53w and a partition portion 53s defining the recess portion 53a1 and the recess portion 53a2. The recess portion 53a1 accommodates the head chip 54-1. The recess portion 53a2 accommodates the head chip 54-2. The surface FH5 is a surface provided on the partition portion 53s between the recess portion 53a1 and the recess portion 53a2 and is a plane facing the Z2 direction. The surface FH6 is a surface provided at a position in the X2 direction with respect to an opening of the recess portion 53a1 and is a plane facing the Z2 direction. The surface FH7 is a surface provided at a position in the X1 direction with respect to an opening of the recess portion 53a2 and is a plane facing the Z2 direction. The surface FH1 that is a bottom surface of the recess portion 53a1 is a surface perpendicular to the Z2 direction and is not parallel to the upper surface of the head chip 54-1 on which the inlet HL is provided. The surface FH2 that is a bottom surface of the recess portion 53a2 is a surface perpendicular to the 22 direction and is not parallel to the upper surface of the head chip 54-2 on which the inlet HL is provided. Therefore, by providing the holder 53G with flow path pipes 53h1 and 53h2 that have different lengths from each other and that protrude from the surface FH1 and the surface FH2, respectively, in the Z2 direction, flow path coupling between the flow path pipes 53h1 and 53h2 and the inlets HL can be facilitated. The flow path pipes 53h1 and 53h2 may be provided in the head chips 54 instead of the holder 53G.

The fixing plate 55G is configured in the same manner as the fixing plate 55 of the first embodiment except that a flat plate portion BDa and bent portions BEa and BEb are provided instead of the bent portion BE, and flat plate portions BDb and BDc and bent portions BEc and BEd are added.

The first flat plate portion BD1 is adjacent to the flat plate portion BDa through the bent portion BEa that is a bent part, and is adjacent to the flat plate portion BDb through the bent portion BEc that is a bent part. Meanwhile, the second flat plate portion BD2 is adjacent to the flat plate portion BDa through the bent portion BEb that is a bent part, and is adjacent to the flat plate portion BDc through the bent portion BEd that is a bent part.

The flat plate portion BDa is a flat plate-shaped part that is a part of the fixing plate 55G, and to which the head chips 54 are not fixed. The flat plate portion BDa faces a different direction from both of the first surface F1 and the second surface F2 and couples the first flat plate portion BD1 to the second flat plate portion BD2. Accordingly, a bending angle in one bent portion of each of the bent portions BEa and BEb can be reduced compared to a case where the first flat plate portion BD1 and the second flat plate portion BD2 are coupled through only the bent portion BE, as in the first embodiment. Thus, spring back can be reduced. By fixing the surface FH5 of the partition portion 53s of the holder 53G to the flat plate portion BDa, deformation of the fixing plate 55G can be reduced. Instead of the partition portion 53s, a sensing element such as a temperature sensor can be disposed on a surface of the flat plate portion BDa facing a direction opposite to the second direction D2. From a viewpoint of achieving size reduction of the liquid ejecting head 50G and reducing the difference in the landing time between the liquid from the head chip 54-1 and the liquid from the head chip 54-2, a length, in the third direction D3, of the flat plate portion BDa to which the head chips 54 are not fixed is preferably smaller than a length of each of the first flat plate portion BD1 and the second flat plate portion BD2 in the third direction D3.

Each of the flat plate portions BDb and BDc extends along a surface perpendicular to the second direction D2 and is a flat plate-shaped part that is a part of the fixing plate 55G, and to which the head chips 54 are not fixed. The flat plate portion BDb is disposed in the X2 direction that is an example of the third direction D3, with respect to the plurality of head chips 54. The flat plate portion BDc is disposed in the X1 direction with respect to the plurality of head chips 54. Accordingly, since the surfaces FH6 and FH7 that are tip end surfaces of the outer peripheral wall portion 53w of the holder 53G are surfaces perpendicular to the second direction D2, assemblability can be improved.

The present modification example described above also achieves the same effect as the first embodiment.

### 2. Second Embodiment

Hereinafter, a second embodiment of the present disclosure will be described. In the embodiment illustrated below, elements having the same effects and functions as those of the first embodiment will be designated by the reference numerals used in the description of the first embodiment, and each of the elements will not be described in detail, as appropriate.

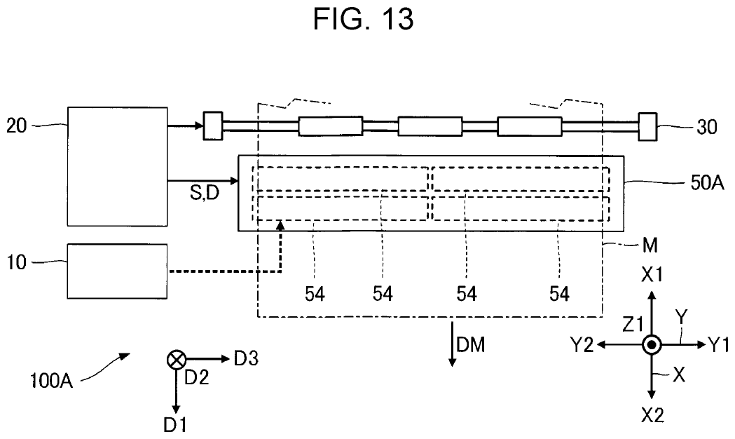

FIG. 13 is a schematic view of a liquid ejecting apparatus 100A according to the present embodiment. The liquid ejecting apparatus 100A includes a line system and is configured in the same manner as the liquid ejecting head 50 of the first embodiment except that the moving mechanism 40 is omitted, and a liquid ejecting head 50A is included instead of the liquid ejecting head 50. In the liquid ejecting apparatus 100A, the transport direction DM of the medium M for the transport portion 30 is the X2 direction, and a width direction of the medium M is the direction along the Y axis.

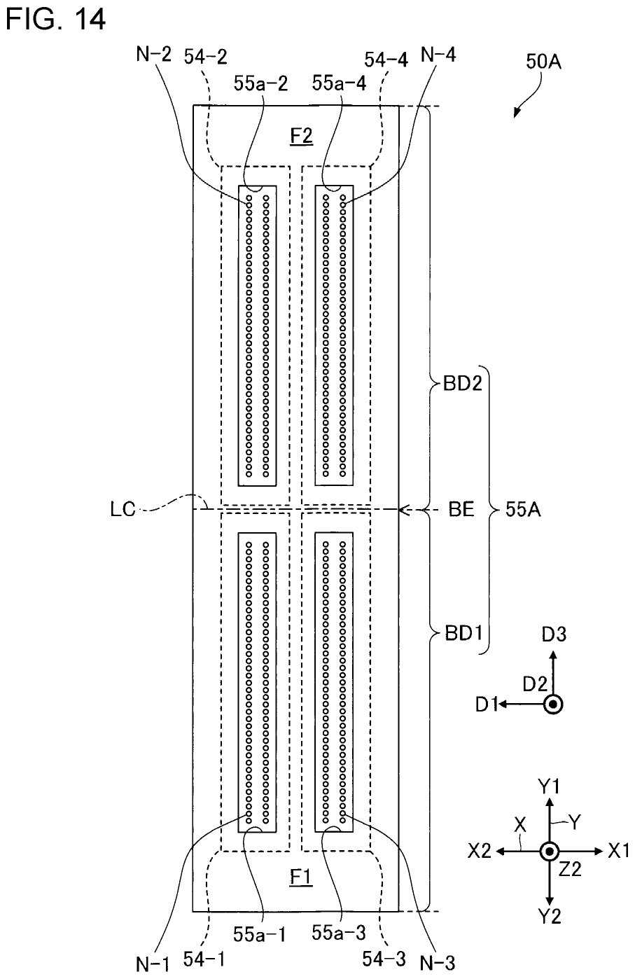

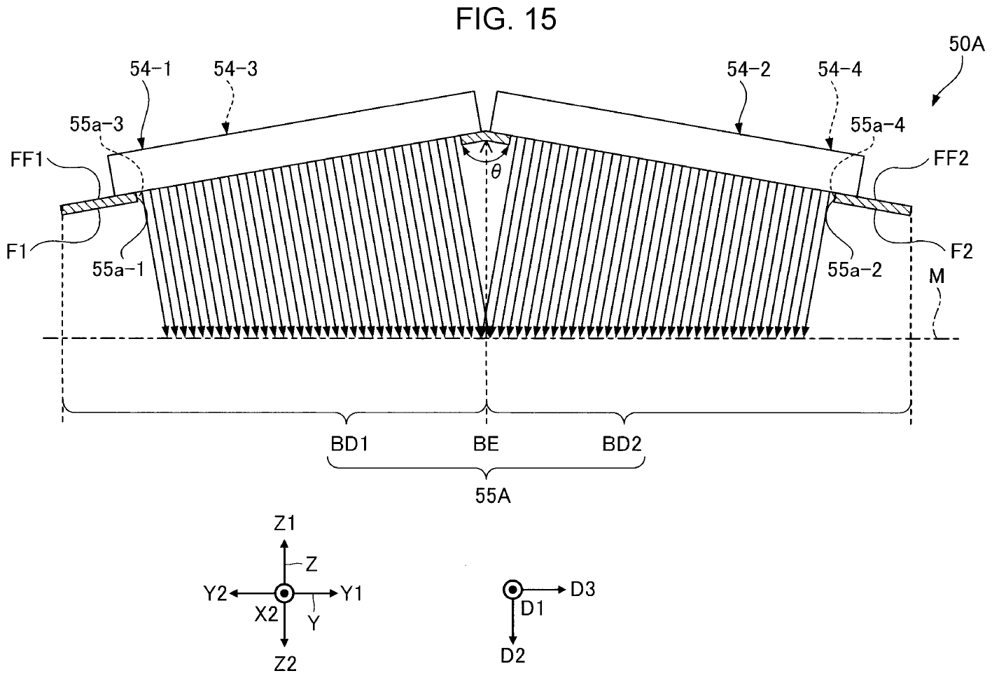

FIG. 14 is a bottom view of the liquid ejecting head 50A according to the present embodiment. FIG. 15 is a descriptive view of the liquid ejecting head 50A according to the present embodiment. The liquid ejecting head 50A is configured in the same manner as the liquid ejecting head 50 of the first embodiment except for having a configuration with a different number and disposition of the head chips 54 such that the plurality of nozzles N are distributed across the whole width of the medium M. The liquid ejecting head 50A includes a fixing plate 55A instead of the fixing plate 55 of the first embodiment and includes the head chips 54-1 to 54-4 as the head chips 54. In FIG. 15, a configuration of the liquid ejecting head 50A other than the fixing plate 55A and the head chips 54 is not illustrated.

In the present embodiment, at a position facing the liquid ejecting head 50A, the transport portion 30 transports the medium M in the first direction D1 along a surface perpendicular to the second direction D2. That is, an aspect of applying the liquid ejecting head 50A to the line system is illustrated. The X2 direction corresponds to the first direction D1, the Z2 direction corresponds to the second direction D2, and the Y1 direction corresponds to the third direction D3.

The fixing plate 55A is configured in the same manner as the fixing plate 55 of the first embodiment except for having a different number and disposition of the exposed opening portions 55a. In the present embodiment, the intersection line LC is parallel to the X axis.

In the fixing plate 55A, the first flat plate portion BD1 is provided with exposed opening portions 55a-1 and 55a-3, and the head chips 54-1 and 54-3 are fixed to the first fixing surface FF1 through an adhesive or the like. Meanwhile, in the fixing plate 55A, the second flat plate portion BD2 is provided with exposed opening portions 55a-2 and 55a-4, and the head chips 54-2 and 54-4 are fixed to the second fixing surface FF2 through an adhesive or the like.

As illustrated in FIG. 14, the exposed opening portion 55a-1 exposes the plurality of nozzles N−1, which are the nozzles N as an example of the “first nozzle”, outward. The exposed opening portion 55a-2 exposes the plurality of nozzles N−2, which are the nozzles N as an example of the “second nozzle”, outward. The exposed opening portion 55a-3 exposes a plurality of nozzles N−3 that are the nozzles N, outward. The exposed opening portion 55a-4 exposes a plurality of nozzles N−4 that are the nozzles N, outward.

In the present embodiment, the same type of the ink is ejected from the head chip 54-1 and the head chip 54-2, and the same type of the ink is ejected from the head chip 54-3 and the head chip 54-4. Specifically, in the case of ejecting magenta ink from the head chip 54-1 and the head chip 54-2 and ejecting cyan ink from the head chip 54-3 and the head chip 54-4, the liquid ejecting head 50A can be used as a line head corresponding to multiple colors.

The type of the ink ejected from the head chip 54-1 and the head chip 54-2 may be the same as the type of the ink ejected from the head chip 54-3 and the head chip 54-4. In this case, resolution may be improved by disposing the nozzle row of the head chip 54-1 and the nozzle row of the head chip 54-2 to be shifted by half of a pitch between the nozzles N constituting the nozzle row, and disposing the head chip 54-3 and the head chip 54-4 in the same manner. The ink ejected from at least one of the head chip 54-1 or the head chip 54-3 may be of the same type as the ink ejected from at least one of the head chip 54-2 or the head chip 54-4.

In the present embodiment, the exposed opening portion 55a-1 and the exposed opening portion 55a-2 are arranged in this order in the Y1 direction. The head chip 54-1 and the head chip 54-2 are arranged in this order in the Y1 direction. In a view from the direction opposite to the second direction D2, the plurality of nozzles N−1 are arranged along the third direction D3, and the plurality of nozzles N−2 are arranged along the third direction D3.

Similarly, the exposed opening portion 55a-3 and the exposed opening portion 55a-4 are arranged in this order in the Y1 direction. The head chip 54-3 and the head chip 54-4 are arranged in this order in the Y1 direction. In the view from the direction opposite to the second direction D2, the plurality of nozzles N−3 are arranged along the third direction D3, and the plurality of nozzles N−4 are arranged along the third direction D3.

In the example illustrated in FIG. 14, the exposed opening portion 55a-1 and the exposed opening portion 55a-3 are arranged in this order in the X1 direction. Thus, the head chip 54-1 and the head chip 54-3 are arranged in this order in the X1 direction. Similarly, the exposed opening portion 55a-2 and the exposed opening portion 55a-4 are arranged in this order in the X1 direction. Thus, the head chip 54-2 and the head chip 54-4 are arranged in this order in the X1 direction.

As illustrated in FIG. 15, in the view from the first direction D1, the angle θ formed between the first surface F1 and the second surface F2 is less than 180 degrees. Accordingly, the landing position of the liquid from the head chip 54-1 and the landing position of the liquid from the head chip 54-2 can be brought closer to each other. Similarly, the landing position of the liquid from the head chip 54-3 and the landing position of the liquid from the head chip 54-4 can be brought closer to each other.

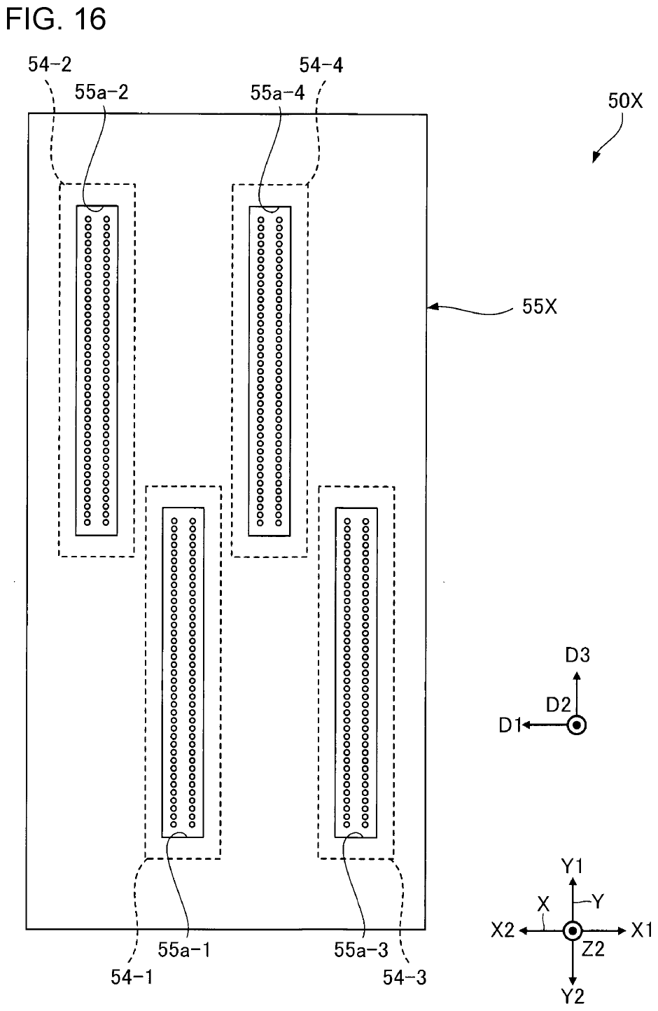

The arrows in FIG. 15 schematically illustrate a trajectory of the ink ejected from each nozzle N of each head chip 54 until the ink lands on the medium M. In the example illustrated in FIG. 15, a boundary part between a landing region of the liquid from the head chip 54-1 and a landing region of the liquid from the head chip 54-2 includes an overlapping region in which a part of the landing region of the liquid from the head chip 54-1 (an end portion of the landing region in the Y1 direction) and a part of the landing region of the liquid from the head chip 54-2 (an end portion of the landing region in the Y2 direction) overlap with each other. Similarly, a part of a landing region of the liquid from the head chip 54-3 (an end portion of the landing region in the Y1 direction) and a part of a landing region of the liquid from the head chip 54-4 (an end portion of the landing region in the Y2 direction) overlap with each other. Thus, as illustrated in FIG. 16 described later, the effective printing width of the liquid ejecting head 50A as a line head can be increased by simply arranging the head chip 54-1 and the head chip 54-2 in the direction along the Y axis without shifting the head chips 54-1 to 54-4 from each other in the direction along the X axis, and a decrease in the printing quality in the above boundary part can be reduced by providing the overlapping region. Consequently, a size of the liquid ejecting head 50A in the direction along the X axis can be reduced.

FIG. 16 is a descriptive view of a liquid ejecting head 50Y in the related art. The liquid ejecting head 50Y is configured in the same manner as the liquid ejecting head 50A except that ejection directions of the head chips 54-1 to 54-4 are parallel to the Z axis, and disposition of the head chips 54-1 to 54-4 is different. The liquid ejecting head 50Y includes a fixing plate 55Y instead of the fixing plate 55A. The fixing plate 55Y is configured in the same manner as the fixing plate 55A except that disposition of the exposed opening portions 55a-1 to 55a-4 is different, and the whole fixing plate 55Y has a shape along a plane.

In the liquid ejecting head 50Y, since the whole fixing plate 55Y has a shape along a plane, the ejection directions of the head chips 54-1 to 54-4 are parallel to the Z axis. Thus, in order to cause a part of the landing region of the liquid from the head chip 54-1 and a part of the landing region of the liquid from the head chip 54-2 to overlap with each other on the medium M, it is required to dispose the head chip 54-1 and the head chip 54-2 to be shifted from each other in the direction along the X axis, as illustrated in FIG. 16. Similarly, it is required to dispose the head chip 54-3 and the head chip 54-4 to be shifted from each other in the direction along the X axis. In the aspect of shifting the head chips 54-1 to 54-4 from each other in the direction along the X axis, a size of the liquid ejecting head 50Y in the direction along the Y axis is increased.

Meanwhile, in the liquid ejecting head 50A, as described above, it is not required to shift the head chips 54-1 to 54-4 from each other in the direction along the X axis. Thus, the size of the liquid ejecting head 50A in the direction along the X axis can be reduced compared to that of the liquid ejecting head 50Y.

In the liquid ejecting head 50Y, in the case of causing the droplet ejected from the head chip 54-1 and the droplet ejected from the head chip 54-2 to land on the medium M at the same position in the direction along the X axis on the medium M, landing timings at which the droplets land on the medium M are different because the head chip 54-1 and the head chip 54-2 are disposed to be shifted in the X axis direction. When the landing timings are different, an effect of a shift in the landing position may emerge depending on transport accuracy.

Meanwhile, in the liquid ejecting head 50A, as described above, it is not required to shift the head chips 54-1 and 54-2 in the direction along the X axis. Thus, the printing quality can be improved by setting the same landing timing. The same applies to the head chips 54-3 and 54-4.

As illustrated in FIG. 14, in the liquid ejecting head 50A, an interval between a group of the head chips 54-1 and 54-2 and a group of the head chips 54-3 and 54-4 in the first direction D1 can be set to be smaller than a dimension of the head chip 54 in the first direction D1. This can also improve the printing quality.

In the liquid ejecting head 50A, even when the head chip 54-1 and the head chip 54-2 are brought closer to each other in the third direction D3 in order to secure the overlapping region, the head chip 54-1 and the head chip 54-2 can be disposed at an interval in an upper part on a side opposite to the nozzle surfaces FN of the head chips 54 by bending the fixing plate 55A. Thus, the head chips 54-1 and 54-2 can be aligned on the bent fixing plate 55A by holding both end portions of the head chips 54 in the y axis direction that is a longitudinal direction.

### 2-A. Modification Example of Second Embodiment

Hereinafter, a modification example of the second embodiment of the present disclosure will be described. In the embodiment illustrated below, elements having the same effects and functions as those of the second embodiment will be designated by the reference numerals used in the description of the second embodiment, and each of the elements will not be described in detail, as appropriate.

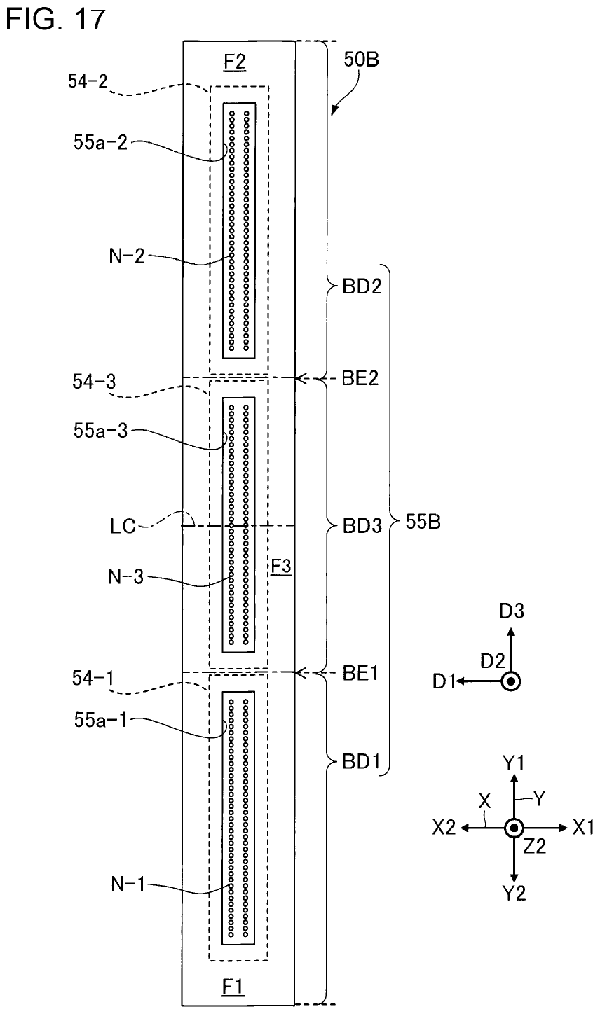

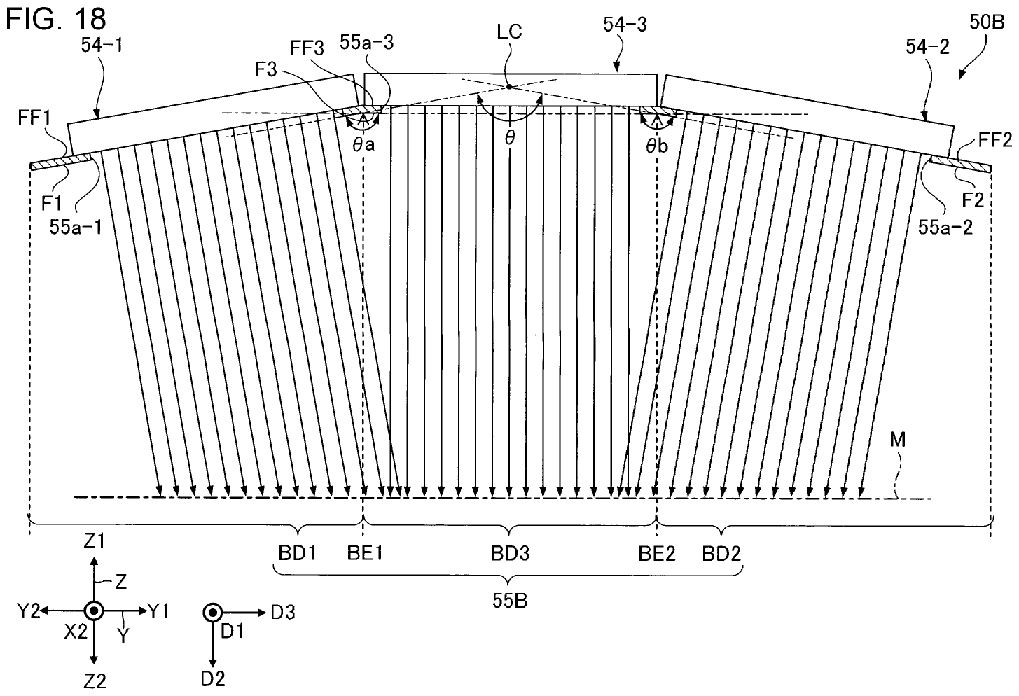

FIG. 17 is a bottom view of a liquid ejecting head 50B according to the present modification example. FIG. 18 is a descriptive view of the liquid ejecting head 50B according to the present modification example. In FIG. 18, a configuration of the liquid ejecting head 50B other than a fixing plate 55B and the head chips 54 is not illustrated. The liquid ejecting head 50B is configured in the same manner as the liquid ejecting head 50A of the second embodiment except for having a configuration with a different number and disposition of the head chips 54. The liquid ejecting head 50B includes the fixing plate 55B instead of the fixing plate 55A of the second embodiment and includes the head chips 54-1 to 54-3. The head chip 54-1 is an example of the “first head chip”, and the head chip 54-2 is an example of the “second head chip”. The head chip 54-3 is an example of a “third head chip” and includes the plurality of nozzles N−3 that are examples of a “third nozzle”.

As in the second embodiment, at a position facing the liquid ejecting head 50B, the transport portion 30 transports the medium M in the first direction D1 along a surface perpendicular to the second direction D2. That is, an aspect of applying the liquid ejecting head 50B to the line system such that the transport direction DM of the medium M for the transport portion 30 is the X2 direction and the width direction of the medium M is the direction along the Y axis is illustrated. The X2 direction corresponds to the first direction D1, the Z2 direction corresponds to the second direction D2, and the Y1 direction corresponds to the third direction D3.

The fixing plate 55B is configured in the same manner as the fixing plate 55A of the second embodiment except for having a different number and disposition of the exposed opening portions 55a.

The fixing plate 55B includes a third flat plate portion BD3 in addition to the first flat plate portion BD1 and the second flat plate portion BD2. The first flat plate portion BD1 and the second flat plate portion BD2 are coupled through the third flat plate portion BD3. That is, the third flat plate portion BD3 is disposed between the first flat plate portion BD1 and the second flat plate portion BD2 in the third direction D3.

The third flat plate portion BD3 is a plate-shaped part that is a part of the fixing plate 55B and that includes a third fixing surface FF3, a third surface F3, and the exposed opening portion 55a-3. The exposed opening portion 55a-3 is the exposed opening portion 55a as an example of a “third exposed opening portion”.

The head chip 54-3 is fixed to the third fixing surface FF3 through an adhesive or the like. The third surface F3 is a surface opposite to the third fixing surface FF3. In the example illustrated in FIG. 18, the third surface F3 is a surface perpendicular to the second direction D2. The exposed opening portion 55a-3 exposes the plurality of nozzles N−3 outward.

The exposed opening portion 55a-1, the exposed opening portion 55a-3, and the exposed opening portion 55a-2 are arranged in this order in the Y1 direction, that is, the third direction D3. The head chip 54-1, the head chip 54-3, and the head chip 54-2 are arranged in this order in the Y1 direction, that is, the third direction D3.

The third surface F3 is caused to face a different direction from the first surface F1 and the second surface F2 by bending the fixing plate 55B, and in the view from the first direction D1, each of an angle θa formed between the third surface F3 and the first surface F1 and an angle θb formed between the third surface F3 and the second surface F2 is less than 180 degrees. In other words, in the view from the first direction D1, a third half-line extending in a direction perpendicular to the third surface F3 from the third surface F3 intersects with both of the first half-line extending in the direction perpendicular to the first surface F1 from the first surface F1 and the second half-line extending in the direction perpendicular to the second surface F2 from the second surface F2. Accordingly, the landing position of the liquid from the head chip 54-1 and the landing position of the liquid from the head chip 54-3 can be brought closer to each other, and the landing position of the liquid from the head chip 54-2 and the landing position of the liquid from the head chip 54-3 can be brought closer to each other. Specifically, a boundary part between the landing region of the liquid from the head chip 54-1 and the landing region of the liquid from the head chip 54-2 includes an overlapping region in which a part of the landing region of the liquid from the head chip 54-1 (the end portion of the landing region in the Y1 direction) and a part of the landing region of the liquid from the head chip 54-2 (the end portion of the landing region in the Y2 direction) overlap with each other. A boundary part between the landing region of the liquid from the head chip 54-3 and the landing region of the liquid from the head chip 54-2 includes an overlapping region in which a part of the landing region of the liquid from the head chip 54-3 (the end portion of the landing region in the Y1 direction) and a part of the landing region of the liquid from the head chip 54-2 (the end portion of the landing region in the Y2 direction) overlap with each other. Accordingly, each of a relationship between the head chip 54-1 and the head chip 54-3 and a relationship between the head chip 54-2 and the head chip 54-3 can achieve the same effect as the relationship between the head chip 54-1 and the head chip 54-2 in the second embodiment. By providing three flat plate portions to which the head chips 54 are fixed, and disposing the flat plate portions to face different directions from each other, the effective printing width as a line head can be set to be longer than that of the second embodiment. The number of flat plate portions to which the head chips 54 are fixed may be four or more.

The fixing plate 55B includes bent portions BE1 and BE2. The bent portion BE1 is a bent part between the first flat plate portion BD1 and the third flat plate portion BD3. The first flat plate portion BD1 and the third flat plate portion BD3 are adjacent to each other through the bent portion BE1. The bent portion BE2 is a bent part between the second flat plate portion BD2 and the third flat plate portion BD3. The second flat plate portion BD2 and the third flat plate portion BD3 are adjacent to each other through the bent portion BE2. Each of the bent portions BE1 and BE2 may be provided with the thin portion TH, like the bent portion BE of the first embodiment.

Each of the angles θa and θb is preferably in the same range as the angle θ of the first embodiment.

In the present modification example, since the fixing plate 55B includes the third flat plate portion BD3 between the first flat plate portion BD1 and the second flat plate portion BD2, the first surface F1 and the second surface F2 do not intersect with each other. In this case, as illustrated in FIG. 18, the intersection line LC between the first surface F1 and the second surface F2 may be interpreted as corresponding to an intersection line between a virtual plane parallel to the first surface F1 and a virtual plane parallel to the second surface F2.

### 3. Modification Example

The embodiments illustrated above may be modified in various ways. Specific aspects of modification that may be applied to the above embodiments will be illustrated below. Any two or more aspects selected from the following illustration may be appropriately combined with each other without contradiction.

### 3-1. Modification Example 1

While the above embodiments illustrate the liquid ejecting apparatus including any one of the liquid ejecting heads 50, 50A, 50B, 50C, 50D, 50E, and 50G, the present disclosure is not limited to this aspect. The liquid ejecting apparatus may include a plurality of any of the liquid ejecting heads 50, 50A, 50B, 50C, 50D, 50E, and 50G. Two or more of the liquid ejecting heads 50, 50A, 50B, 50C, 50D, 50E, and 50G may be combined with each other.

### 3-2. Modification Example 2

In the above embodiments, the aspect of the number, disposition, directions, or the like of the head chips 54 included in the liquid ejecting heads 50, 50A, 50B, 50C, 50D, 50E, and 50G are merely an example and may be appropriately changed within a scope of the effects of the present disclosure.

### 3-3. Modification Example 3

The liquid ejecting heads 50, 50C, 50D, 50E, and 50G of the first embodiment and each modification example thereof may be applied to the line system described in the second embodiment. In this case, the transport portion 30 transports the medium M in the third direction D3 along a surface perpendicular to the second direction D2 at the positions facing the liquid ejecting heads 50, 50C, 50D, 50E, and 50G. That is, the liquid ejecting heads 50, 50C, 50D, 50E, and 50G may be applied to the line system such that the transport direction DM of the medium M for the transport portion 30 is the X2 direction, and the width direction of the medium M is the direction along the Y axis. The Y1 direction corresponds to the first direction D1, the Z2 direction corresponds to the second direction D2, and the X2 direction corresponds to the third direction D3. This can also achieve the same effect as each of the first embodiment and each modification example thereof. The combination of the types of the liquid ejected from each head chip 54 may be the same as that described in each of the first embodiment and each modification example thereof.

### 3-4. Modification Example 4

In the first embodiment and each modification example thereof, it may be configured to provide three or more flat plate portions to which the head chips 54 are fixed and dispose the flat plate portions to face different directions from each other, as in the modification example of the second embodiment.

### 3-5. Modification Example 5

In the second embodiment and the modification example thereof, the liquid ejecting heads 50A and 50B may be applied to the serial system described in the first embodiment. The transport portion 30 transports the medium M in the third direction D3 along a surface perpendicular to the second direction D2 at the positions facing the liquid ejecting heads 50A and 50B. The liquid ejecting heads 50A and 50B may be applied to the line system such that the moving mechanism 40 causes the liquid ejecting heads 50A and 50B to reciprocate along an axis along the first direction D1. The X2 direction corresponds to the first direction D1, the Z2 direction corresponds to the second direction D2, and the Y1 direction corresponds to the third direction D3. This can also increase the effective printing width with which the liquid ejecting heads 50A and 50B can perform printing by performing scanning once, without increasing sizes of the liquid ejecting heads 50A and 50B in the main scanning direction of the moving mechanism 40. Thus, the same effect as each of the second embodiment and the modification example thereof can be achieved. The combination of the types of the liquid ejected from each head chip 54 may be the same as that described in each of the second embodiment and the modification example thereof.

### 3-6. Modification Example 6

The liquid ejecting apparatus illustrated in the above embodiments may be adopted in various apparatuses such as a facsimile apparatus and a copy machine, in addition to an apparatus dedicated to printing. Application of the liquid ejecting apparatus is not limited to printing. For example, a liquid ejecting apparatus that ejects a solution of a coloring material is used as a manufacturing apparatus that forms a color filter of a display device such as a liquid crystal display panel. A liquid ejecting apparatus that ejects a solution of a conductive material is used as a manufacturing apparatus that forms wiring or an electrode of a wiring substrate. A liquid ejecting apparatus that ejects a solution of an organic material related to a living body is used as, for example, a manufacturing apparatus that manufactures a biochip.

### 4. Appendix

The present disclosure is summarized as follows.

### Appendix 1

In a first aspect that is a preferred example of the liquid ejecting head of the present disclosure, a liquid ejecting head includes a plurality of head chips that include a first head chip including a plurality of first nozzles that eject liquid, and a second head chip including a plurality of second nozzles that eject the liquid, and a fixing plate that includes a first exposed opening portion exposing the plurality of first nozzles outward, and a second exposed opening portion exposing the plurality of second nozzles outward, and to which the plurality of head chips are fixed, in which the fixing plate includes a first flat plate portion including a first fixing surface to which the first head chip is fixed, and a first surface opposite to the first fixing surface, and a second flat plate portion including a second fixing surface to which the second head chip is fixed, and a second surface opposite to the second fixing surface, the first surface and the second surface are caused to face different directions from each other by bending the fixing plate, and in a view from a first direction along an intersection line between the first surface and the second surface, an angle formed between the first surface and the second surface is less than 180 degrees.

### Appendix 2

In a second aspect that is a preferred example of the first aspect, the fixing plate includes a bent portion bent between the first flat plate portion and the second flat plate portion, and the first flat plate portion and the second flat plate portion are adjacent to each other via the bent portion.

### Appendix 3

In a third aspect that is a preferred example of the first or second aspect, the liquid ejecting head further includes a flow path structure that includes one or a plurality of flow paths communicating with each flow path of the plurality of head chips and that is configured by laminating a plurality of substrates in a second direction, in which, in the view from the first direction, an angle formed between a straight line extending in the second direction and the first surface is equal to an angle formed between a straight line extending in the second direction and the second surface.

### Appendix 4

In a fourth aspect that is a preferred example of any one of the first to third aspects, the fixing plate includes a bent portion that is bent between the first flat plate portion and the second flat plate portion, and the bent portion includes a thin portion having a smaller thickness than the first flat plate portion.

### Appendix 5

In a fifth aspect that is a preferred example of any one of the first to fourth aspects, the plurality of head chips include a third head chip including a plurality of third nozzles that eject the liquid, the fixing plate includes a third flat plate portion including a third fixing surface to which the third head chip is fixed, a third surface opposite to the third fixing surface, and a third exposed opening portion exposing the plurality of third nozzles outward, the third surface is caused to face a different direction from the first surface and the second surface by bending the fixing plate, and in the view from the first direction, each of an angle formed between the third surface and the first surface and an angle formed between the third surface and the second surface is less than 180 degrees.

### Appendix 6

In a sixth aspect that is a preferred example of the fifth aspect, the liquid ejecting head further includes a flow path structure that includes one or a plurality of flow paths communicating with each flow path of the plurality of head chips and that is configured by laminating a plurality of substrates in a second direction, in which, in a third direction orthogonal to both of the first direction and the second direction, the third flat plate portion is disposed between the first flat plate portion and the second flat plate portion, and the third surface is a surface perpendicular to the second direction.

### Appendix 7

In a seventh aspect that is a preferred example of any one of the first to fourth aspects, the fixing plate includes a flat plate portion to which the head chips are not fixed, and the flat plate portion faces a different direction from both of the first surface and the second surface and couples the first flat plate portion and the second flat plate portion.

### Appendix 8

In an eighth aspect that is a preferred example of any one of the first to seventh aspects, the liquid ejecting head further includes a flow path structure that includes one or a plurality of flow paths communicating with each flow path of the plurality of head chips and that is configured by laminating a plurality of substrates in a second direction, in which the fixing plate includes a flat plate portion to which the head chips are not fixed, and the flat plate portion extends along a surface perpendicular to the second direction and is disposed in a third direction orthogonal to both of the first direction and the second direction, with respect to the plurality of head chips.

### Appendix 9

In a ninth aspect that is a preferred example of the liquid ejecting head of the present disclosure, a liquid ejecting head includes a plurality of head chips that include a first head chip including a plurality of first nozzles that eject liquid, and a second head chip including a plurality of second nozzles that eject the liquid, and a fixing plate that includes a first exposed opening portion exposing the plurality of first nozzles outward, and a second exposed opening portion exposing the plurality of second nozzles outward, and to which the plurality of head chips are fixed, in which the fixing plate includes a first flat plate portion including a first fixing surface to which the first head chip is fixed, and a first surface opposite to the first fixing surface, and a second flat plate portion including a second fixing surface to which the second head chip is fixed, and a second surface opposite to the second fixing surface, the first surface and the second surface are caused to face different directions from each other by bending the fixing plate, and in a view from a first direction along an intersection line between the first surface and the second surface, a first half-line extending in a direction perpendicular to the first surface from the first surface and a second half-line extending in a direction perpendicular to the second surface from the second surface intersect with each other.

### Appendix 10

In a tenth aspect that is a preferred example of the ninth aspect, the liquid ejecting head further includes a flow path structure that includes one or a plurality of flow paths communicating with each flow path of the plurality of head chips and that is configured by laminating a plurality of substrates in a second direction, in which the fixing plate includes a bent portion that is bent between the first flat plate portion and the second flat plate portion, the first flat plate portion and the second flat plate portion are adjacent to each other through the bent portion, the plurality of head chips are disposed in the second direction with respect to the flow path structure, in the view from the first direction, a center position of the plurality of first nozzles is a first position, in the view from the first direction, a center position of the plurality of second nozzles is a second position, an end of the fixing plate in the second direction is positioned at a third position, and when a distance between the first position and the second position in a third direction orthogonal to both of the first direction and the second direction is denoted by L1, a distance between the first position and the third position in the second direction is denoted by L2, a distance between the second position and the third position in the second direction is denoted by L3, in the view from the first direction, an angle formed between a straight line extending in the second direction and the first half-line is denoted by θ1, in the view from the first direction, an angle formed between a straight line extending in the second direction and the second half-line is denoted by θ2, and a length of a line segment linking the center position of the plurality of first nozzles in an arrangement direction to the center position of the plurality of second nozzles in the arrangement direction when the first head chip and the second head chip are adjacent to each other in the arrangement direction to be in contact with each other, and each nozzle surface of the first head chip and the second head chip is disposed to face the same direction is denoted by R, L1−(L2×tan θ1+L3×tan θ2)<R is satisfied.

### Appendix 11

In an eleventh aspect that is a preferred example of any one of the first to tenth aspects, the plurality of first nozzles are arranged along the first direction, and the plurality of second nozzles are arranged along the first direction.

### Appendix 12

In a twelfth aspect that is a preferred example of the liquid ejecting apparatus of the present disclosure, a liquid ejecting apparatus includes the liquid ejecting head of the eleventh aspect, and a transport portion that transports a medium on which liquid ejected from the liquid ejecting head lands, in which the liquid ejecting head includes a flow path structure that includes one or a plurality of flow paths communicating with each flow path of the plurality of head chips and that is configured by laminating a plurality of substrates in a second direction, and at a position facing the liquid ejecting head, the transport portion transports the medium in a third direction perpendicular to the first direction and the second direction along a surface perpendicular to the second direction.

### Appendix 13

In a thirteenth aspect that is a preferred example of the liquid ejecting apparatus of the present disclosure, a liquid ejecting apparatus includes the liquid ejecting head of the eleventh aspect, and a transport portion that transports a medium on which liquid ejected from the liquid ejecting head lands, in which the liquid ejecting head includes a flow path structure that includes one or a plurality of flow paths communicating with each flow path of the plurality of head chips and that is configured by laminating a plurality of substrates in a second direction, and at a position facing the liquid ejecting head, the transport portion transports the medium in the first direction along a surface perpendicular to the second direction.

### Appendix 14

In a fourteenth aspect that is a preferred example of any one of the first to eleventh aspects, the liquid ejecting head further includes a flow path structure that includes one or a plurality of flow paths communicating with each flow path of the plurality of head chips and that is configured by laminating a plurality of substrates in a second direction, in which the plurality of first nozzles are arranged along a third direction orthogonal to both of the first direction and the second direction, and the plurality of second nozzles are arranged along the third direction.

### Appendix 15

In a fifteenth aspect that is a preferred example of the liquid ejecting apparatus of the present disclosure, a liquid ejecting apparatus includes the liquid ejecting head of the fourteenth aspect, and a transport portion that transports a medium on which liquid ejected from the liquid ejecting head lands, in which, at a position facing the liquid ejecting head, the transport portion transports the medium in the first direction along a surface perpendicular to the second direction.

### Appendix 16

In a sixteenth aspect that is a preferred example of the liquid ejecting apparatus of the present disclosure, a liquid ejecting apparatus includes the liquid ejecting head of the fourteenth aspect, and a transport portion that transports a medium on which liquid ejected from the liquid ejecting head lands, in which, at a position facing the liquid ejecting head, the transport portion transports the medium in the third direction along a surface perpendicular to the second direction.

### Appendix 17

In a seventeenth aspect that is a preferred example of the liquid ejecting apparatus of the present disclosure, a liquid ejecting apparatus includes the liquid ejecting head of any one of the first to tenth aspects, and a transport portion that transports a medium on which liquid ejected from the liquid ejecting head lands.

### Appendix 18

In an eighteenth aspect that is a preferred example of the seventeenth aspect, the liquid ejecting head includes a flow path structure that includes one or a plurality of flow paths communicating with each flow path of the plurality of head chips and that is configured by laminating a plurality of substrates in a second direction, and at a position facing the liquid ejecting head, the transport portion transports the medium along a surface perpendicular to the second direction.

What is claimed is:

1. A liquid ejecting head comprising:
a plurality of head chips that include a first head chip including first nozzles configured to eject liquid, and a second head chip including second nozzles configured to eject the liquid; and
a fixing plate that includes a first exposed opening portion exposing the first nozzles outward, and a second exposed opening portion exposing the second nozzles outward, and to which the plurality of head chips are fixed, wherein
the fixing plate includes
a first flat plate portion including a first fixing surface to which the first head chip is fixed, and a first surface that is opposite from the first fixing surface, and
a second flat plate portion including a second fixing surface to which the second head chip is fixed, and a second surface that is opposite from the second fixing surface,
the first surface and the second surface are caused to face different directions from each other by bending the fixing plate, and
in a view from a first direction along an intersection line between the first surface and the second surface, an angle formed between the first surface and the second surface is less than 180 degrees.

2. The liquid ejecting head according to claim 1, wherein
the fixing plate includes a bent portion that is bent between the first flat plate portion and the second flat plate portion, and
the first flat plate portion and the second flat plate portion are adjacent to each other through the bent portion.

3. The liquid ejecting head according to claim 1, further comprising:
a flow path structure that includes one or a plurality of flow paths communicating with each flow path of the plurality of head chips and that is configured by laminating substrates in a second direction, wherein
in the view from the first direction, an angle formed between a straight line extending in the second direction and the first surface is equal to an angle formed between a straight line extending in the second direction and the second surface.

4. The liquid ejecting head according to claim 1, wherein
the fixing plate includes a bent portion that is bent between the first flat plate portion and the second flat plate portion, and
the bent portion includes a thin portion having a smaller thickness than the first flat plate portion.

5. The liquid ejecting head according to claim 1, wherein
the plurality of head chips include a third head chip including third nozzles configured to eject the liquid,
the fixing plate includes a third flat plate portion including a third fixing surface to which the third head chip is fixed, a third surface that is opposite from the third fixing surface, and a third exposed opening portion exposing the third nozzles outward,
the third surface is caused to face a different direction from the first surface and the second surface by bending the fixing plate, and
in the view from the first direction, each of an angle formed between the third surface and the first surface and an angle formed between the third surface and the second surface is less than 180 degrees.

6. The liquid ejecting head according to claim 5, further comprising:
a flow path structure that includes one or a plurality of flow paths communicating with each flow path of the plurality of head chips and that is configured by laminating substrates in a second direction, wherein
in a third direction orthogonal to both of the first direction and the second direction, the third flat plate portion is disposed between the first flat plate portion and the second flat plate portion, and
the third surface is a surface perpendicular to the second direction.

7. The liquid ejecting head according to claim 1, wherein
the fixing plate includes a flat plate portion to which the head chips are not fixed, and
the flat plate portion faces a different direction from both of the first surface and the second surface and couples the first flat plate portion and the second flat plate portion.

8. The liquid ejecting head according to claim 1, further comprising:
a flow path structure that includes one or a plurality of flow paths communicating with each flow path of the plurality of head chips and that is configured by laminating substrates in a second direction, wherein
the fixing plate includes a flat plate portion to which the head chips are not fixed, and
the flat plate portion extends along a surface perpendicular to the second direction and is disposed in a third direction orthogonal to both of the first direction and the second direction, with respect to the plurality of head chips.

9. A liquid ejecting head comprising:
a plurality of head chips that include a first head chip including first nozzles that eject liquid, and a second head chip including second nozzles that eject the liquid; and
a fixing plate that includes a first exposed opening portion exposing the first nozzles outward, and a second exposed opening portion exposing the second nozzles outward, and to which the plurality of head chips are fixed, wherein
the fixing plate includes
a first flat plate portion including a first fixing surface to which the first head chip is fixed, and a first surface that is opposite from the first fixing surface, and
a second flat plate portion including a second fixing surface to which the second head chip is fixed, and a second surface that is opposite from the second fixing surface,
the first surface and the second surface are caused to face different directions from each other by bending the fixing plate, and
in a view from a first direction along an intersection line between the first surface and the second surface, a first half-line extending in a direction perpendicular to the first surface from the first surface and a second half-line extending in a direction perpendicular to the second surface from the second surface intersect with each other.

10. The liquid ejecting head according to claim 9, further comprising:
a flow path structure that includes one or a plurality of flow paths communicating with each flow path of the plurality of head chips and that is configured by laminating substrates in a second direction, wherein
the fixing plate includes a bent portion that is bent between the first flat plate portion and the second flat plate portion,
the first flat plate portion and the second flat plate portion are adjacent to each other through the bent portion,
the plurality of head chips are disposed in the second direction with respect to the flow path structure,
in the view from the first direction, a center position of the first nozzles is a first position,
in the view from the first direction, a center position of the second nozzles is a second position,
an end of the fixing plate in the second direction is positioned at a third position, and
$$L 1 - ( L 2 \times tan θ 1 + L 3 \times tan θ 2 ) < R ,$$
a distance between the first position and the second position in a third direction orthogonal to both of the first direction and the second direction is L1,
a distance between the first position and the third position in the second direction is L2,
a distance between the second position and the third position in the second direction is L3,
in the view from the first direction, an angle formed between a straight line extending in the second direction and the first half-line is θ1,
in the view from the first direction, an angle formed between a straight line extending in the second direction and the second half-line is θ2, and
a length of a line segment linking the center position of the first nozzles in an arrangement direction to the center position of the second nozzles in the arrangement direction when the first head chip and the second head chip are adjacent to each other in the arrangement direction to be in contact with each other, and each nozzle surface of the first head chip and the second head chip is disposed to face the same direction is R.

11. The liquid ejecting head according to claim 1, wherein
the first nozzles are arranged along the first direction, and
the second nozzles are arranged along the first direction.

12. A liquid ejecting apparatus comprising:
the liquid ejecting head according to claim 11; and
a transport portion that transports a medium on which liquid ejected from the liquid ejecting head lands, wherein
the liquid ejecting head includes a flow path structure that includes one or a plurality of flow paths communicating with each flow path of the plurality of head chips and that is configured by laminating substrates in a second direction, and
at a position facing the liquid ejecting head, the transport portion transports the medium in a third direction perpendicular to the first direction and the second direction along a surface perpendicular to the second direction.

13. A liquid ejecting apparatus comprising:
the liquid ejecting head according to claim 11; and
a transport portion that transports a medium on which liquid ejected from the liquid ejecting head lands, wherein
the liquid ejecting head includes a flow path structure that includes one or a plurality of flow paths communicating with each flow path of the plurality of head chips and that is configured by laminating substrates in a second direction, and
at a position facing the liquid ejecting head, the transport portion transports the medium in the first direction along a surface perpendicular to the second direction.

14. The liquid ejecting head according to claim 1, further comprising:
a flow path structure that includes one or a plurality of flow paths communicating with each flow path of the plurality of head chips and that is configured by laminating substrates in a second direction, wherein
the first nozzles are arranged along a third direction orthogonal to both of the first direction and the second direction, and
the second nozzles are arranged along the third direction.

15. A liquid ejecting apparatus comprising:
the liquid ejecting head according to claim 14; and
a transport portion that transports a medium on which liquid ejected from the liquid ejecting head lands, wherein
at a position facing the liquid ejecting head, the transport portion transports the medium in the first direction along a surface perpendicular to the second direction.

16. A liquid ejecting apparatus comprising:
the liquid ejecting head according to claim 14; and
a transport portion that transports a medium on which liquid ejected from the liquid ejecting head lands, wherein
at a position facing the liquid ejecting head, the transport portion transports the medium in the third direction along a surface perpendicular to the second direction.

17. A liquid ejecting apparatus comprising:
the liquid ejecting head according to claim 1; and
a transport portion that transports a medium on which liquid ejected from the liquid ejecting head lands.

18. The liquid ejecting apparatus according to claim 17, wherein
the liquid ejecting head includes a flow path structure that includes one or a plurality of flow paths communicating with each flow path of the plurality of head chips and that is configured by laminating substrates in a second direction, and
at a position facing the liquid ejecting head, the transport portion transports the medium along a surface perpendicular to the second direction.

19. A liquid ejecting apparatus comprising:
the liquid ejecting head according to claim 9; and
a transport portion that transports a medium on which liquid ejected from the liquid ejecting head lands.
